(19) United States
(12) Patent Application Publication
(10) Pub. No.: US 2022/0185315 A1
(43) Pub. Date: Jun. 16, 2022

(54) Authentication of Autonomous Vehicle Travel Networks

(71) Applicant: Uber Technologies, Inc., San Francisco, CA (US)

(72) Inventors: Nathan Falk, San Francisco, CA (US); Sara Ahmadi, San Jose, CA (US); Alvin AuYoung, Los Altos, CA (US)

(21) Appl. No.: 17/130,133

(22) Filed: Dec. 22, 2020

Related U.S. Application Data
(60) Provisional application No. 63/125,509, filed on Dec. 15, 2020.

(51) Int. Cl. B60W 60/00; G01C 21/34; G05D 1/00; H04L 9/32

(52) U.S. Cl. CPC B60W 60/001; G01C 21/3461; B60W 2554/4049; H04L 9/3247; G05D 1/0027

(57) ABSTRACT

Systems and methods for authenticating autonomous vehicle travel networks are provided. A system can obtain map data descriptive of a number of segment attributes for a number of travel way segments within a travel way network. The system can obtain operational domain parameters for the travel way segments and generate an operational domain including a number of operational travel way segments with segment attributes that achieve the operational domain parameters. The system can compare the operational domain to approval criteria associated with a service entity to verify that the operational travel way segments of the operational domain comply with service entity policies. The system can provide a verified operational domain to an autonomous vehicle for use in traversing the travel network. An operational domain that does not meet the approval criteria can be modified to comply with the approval criteria before being provided to an autonomous vehicle.

### RELATED APPLICATION

The present application is based, at least in part, on and claims benefit of U.S. Provisional Patent Application No. 63/125,509 having a filing date of Dec. 15, 2020, which is incorporated by reference herein.

### FIELD

The present disclosure relates generally to vehicle services and, more particularly, to improved authentication and management of autonomous vehicle travel networks.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given such knowledge, an autonomous vehicle can navigate through the environment.

### SUMMARY

Aspects and advantages of implementations of the present disclosure will be set forth in part in the following description, or may be learned from the description, or may be learned through practice of the implementations.

An example aspect of the present disclosure is directed to a computing system. The computing system can include one or more processors and one or more tangible, non-transitory, computer readable media that collectively store instructions that when executed by the one or more processors cause the computing system to perform operations. The operations can include obtaining map data associated with a travel way network. The travel way network includes a plurality of travel way segments. The map data includes a plurality of segment attributes for each travel way segment of the plurality of travel way segments. The operations include obtaining one or more operational domain parameters for the plurality of travel way segments. The one or more operational domain parameters are based, at least in part, on approval criteria associated with one or more operational capabilities of a fleet of autonomous vehicles. The operations include generating an operational domain for the fleet of autonomous vehicles based, at least in part, on the map data and the one or more operational domain parameters. The operational domain is indicative of one or more operational travel way segments of the plurality of travel way segments. The operations include generating verification data for the operational domain based, at least in part, on one or more comparisons between the operational domain and the approval criteria. And, the operations include providing the operational domain to an autonomous vehicle of the fleet of autonomous vehicles based, at least in part, on the verification data. The autonomous vehicle is configured to traverse the travel way network based, at least in part, on the operational domain.

Another example aspect of the present disclosure is directed to a computer-implemented method. The method can include obtaining, by a computing system including one or more computing devices, map data associated with a travel way network. The travel way network can include a plurality of travel way segments. The map data includes a plurality of segment attributes for each travel way segment of the plurality of travel way segments. The method can include obtaining, by the computing system, one or more operational domain parameters for the plurality of travel way segments. The one or more operational domain parameters are based, at least in part, on one or more operational capabilities associated with a fleet of autonomous vehicles. The method can include generating, by the computing system, one or more operational domains for the fleet of autonomous vehicles based, at least in part, on the map data and the one or more operational domain parameters. The one or more operational domains can be indicative of one or more operational travel way segments of the plurality of travel way segments. The operational travel way segments can include one or more disconnected operational travel way segments and one or more connected operational travel way segments. The method can include providing travel way network data indicative of at least one of the one or more operational domains to an autonomous vehicle of the fleet of autonomous vehicles. The autonomous vehicle can be configured to traverse the travel way network based, at least in part, on the travel way network data.

Yet another example aspect of the present disclosure is directed to another computing system. The computing system can include one or more display devices, one or more processors and one or more tangible, non-transitory, computer readable media that collectively store instructions that when executed by the one or more processors cause the computing system to perform operations. The operations can include obtaining map data associated with a travel way network including a plurality of travel way segments. The map data can include a plurality of segment attributes for each travel way segment of the plurality of travel way segments. The operations can include obtaining one or more operational domain parameters for the plurality of travel way segments. The one or more operational domain parameters can be based, at least in part, on one or more operational capabilities associated with a fleet of autonomous vehicles. The operations can include generating an operational domain for the fleet of autonomous vehicles indicative of one or more operational travel way segments of the plurality of travel way segments based, at least in part, on the map data and the one or more operational parameters. The operational domain can be indicative of one or more connected operational travel way segments and one or more disconnected operational travel way segments. And, the operations can include providing for display, via the one or more display devices, a map interface indicative of the travel way network, the one or more connected operational travel way segments, and the one or more disconnected operational travel way segments.

Other example aspects of the present disclosure are directed to other systems, methods, vehicles, apparatuses, tangible non-transitory computer-readable media, and the like for authentication and management of autonomous vehicle operational domains.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for controlling the navigation of an autonomous vehicle according to example embodiments of the present disclosure.

FIG. 2 depicts an example infrastructure system according to example embodiments of the present disclosure.

FIG. 3 depicts an example vehicle ecosystem according to example embodiments of the present disclosure.

FIG. 4 depicts an example operational domain service architecture according to example embodiments of the present disclosure.

FIG. 5 depicts an example user query interface according to example embodiments of the present disclosure.

FIG. 6 depicts a modification user interface according to example embodiments of the present disclosure.

FIG. 7 depicts an example current routable travel way network interface according to example embodiments of the present disclosure.

FIG. 8 depicts a flow diagram of an example method for generating travel way network data according to example embodiments of the present disclosure.

FIG. 9 depicts example units associated with a computing system for performing operations and functions according to example embodiments of the present disclosure.

FIG. 10 depicts a block diagram of an example computing system according to example embodiments of the present disclosure.

### DETAILED DESCRIPTION

Example aspects of the present disclosure are directed to improved authentication and control techniques for autonomous vehicles. For instance, the present disclosure describes the generation and verification of operational domains in which autonomous vehicles can safely operate. In particular, a computing system can include a service entity's operations computing system can be configured to obtain map data descriptive of a number of attributes for a number of travel way segments (e.g., road segments) of a travel way network (e.g., road network). The system can obtain operational domain parameters for the plurality of travel way segments that define an acceptable number, range, or value for the attributes of a travel way segment. The operational domain parameters can be determined (e.g., via a user query, automatically based, at least in part, on risk or performance threshold, etc.) in accordance with approval criteria (e.g., criteria outlining requirements for autonomous vehicle navigation based, at least in part, on autonomous capabilities and other policy considerations of the service entity) associated with the service entity. The system can apply the operational domain parameters to the map data to generate an operational domain for a fleet of autonomous vehicles associated with the service entity. The operational domain can include a number of operational travel way segments (e.g., a subset of the number of travel way segments) of the travel way network. The system can generate verification data (e.g., a cryptographic validation signature) for the operational domain by comparing the operational travel way segments (and/or attributes thereof) to the approval criteria and provide the data indicative of a verified operational domain (e.g., operational domain signed by the cryptographic validation signature) to an autonomous vehicle for use in traversing the travel way network.

In this manner, the systems and methods of the present disclosure provide improved techniques for controlling, deploying, and routing autonomous vehicles based, at least in part, on the infrastructure (e.g., attributes) of a travel way network. Moreover, by authenticating operational domains before deployment, the systems and methods of the present disclosure can proactively detect and prevent abnormalities in authenticated operational networks. In this way, the systems and methods disclosed herein can leverage new types of cryptographic signing and authentication techniques to provide an improvement (e.g., vehicle safety) to the functioning of autonomous vehicle computing systems. Ultimately, the systems and methods described herein improve vehicle safety by reliably verifying operational domains for use by autonomous vehicles.

The following describes the technology of this disclosure within the context of autonomous vehicles for example purposes only. As described herein, the technology described herein is not limited to autonomous vehicles and can be implemented within other robotic and computing systems, such as those utilized by ridesharing and/or delivery services.

An autonomous vehicle (e.g., ground-based vehicle, aerial vehicles, bikes, scooters, and other light electric vehicles, etc.) can include various systems and devices configured to control the operation of the vehicle. For example, an autonomous vehicle can include an onboard vehicle computing system (e.g., located on or within the autonomous vehicle) that is configured to operate the autonomous vehicle. Generally, the vehicle computing system can obtain sensor data from a sensor system onboard the vehicle, attempt to comprehend the vehicle's surrounding environment by performing various processing techniques on the sensor data, and generate an appropriate motion plan through the vehicle's surrounding environment. Additionally, the vehicle computing system can communicate with a remote computing system such as, for example, an operations computing system and/or one or more remote devices via a communication system onboard the vehicle. The operations computing system can be associated with a service entity that provides one or more vehicle services (e.g., a ride-sharing service for one or more fleets of vehicles).

The operations computing system of a service entity can include various sub-systems/back-end software services that are configured to perform various functions. For example, the operations computing system can include one or more backend servers configured to host a plurality of backend software services for facilitating one or more transportation services. The plurality of backend software services can include a plurality of different services such as, for example, one or more trip assignment service(s), matching/deployment software service(s), routing service(s), supply positioning service(s), payment service(s), remote operator service(s), operational domain service(s), and/or any other software service that can contribute to the provisioning of a transportation service. As examples, the matching/deployment software service(s) can be configured to receive data indicative of a user service request (e.g., from a service provider computing system, a user computing device, etc.) for a vehicle service, identify a plurality of candidate vehicles available to perform at least a portion of the vehicle route, etc. The routing software service(s) can be configured to determine the vehicle route based, at least in part, on the user service request. And, the trip assignment service(s) can be configured to assign the user service request to a candidate vehicle.

The operations computing system (and/or a backend service provided by the operations computing system) can communicate data indicative of the user service request to the candidate vehicle (e.g., directly and/or indirectly to the vehicles, etc.) or a vehicle provider associated with the candidate vehicle (e.g., service entity service provider, third party service provider, etc.). The candidate vehicle and/or the vehicle provider can perform the requested transportation service by utilizing (e.g., via one or more requests for access to, etc.) one or more of the backend services provided by the operations computing system. In this manner, the operations computing system can be configured to facilitate a transportation service utilizing multiple service providers via a plurality of backend software services.

For example, the vehicles can include human-driven and/or autonomous vehicles of a vehicle provider. The vehicle providers can include the service entity (supplying “first party autonomous vehicles” or “service entity autonomous vehicles”) and/or one or more third-party vehicle providers (supplying “third party autonomous vehicles”). A third-party vehicle provider can be, for example, a third party vehicle vendor, operator, manager, etc. that owns, operates, manages, etc. a fleet of third party autonomous vehicles. In this regard, each of the one or more vehicle providers can be associated with one or more fleets of vehicles. The vehicle providers can make their fleets (or a portion of their fleets) of vehicles available (e.g., through the service entity, etc.) such that the vehicles are available for performing vehicle services (e.g., to address a user service request). Thus, each respective vehicle in the plurality of vehicles can be associated with at least one of the one or more fleets of vehicles associated with the one or more vehicle providers.

An autonomous vehicle can be configured to autonomously operate in various environments based, at least in part, on one or more factors and/or directives (e.g., from the service entity). Each environment can be included in a travel way network (e.g., road network) associated with map data (e.g., a preconstructed and dynamically updated road map information, flight map information including one or more defined ski lanes, water map information including waterways, etc.). The map data, for example, can define one or more portions (e.g., travel way segments) of the travel way network. For example, the travel way network can include a plurality of travel way segments within (and/or or above) a geographic region (e.g., a city, county, town, neighborhood, etc.). The map data can define each of the travel way segments and include a plurality of segment attributes for each travel way segment of the plurality of travel way segments. An autonomous vehicle can be restricted from and/or approved to operate in certain environments (e.g., portions) of a travel way network. For example, an autonomous vehicle can be approved for operating within an environment due to legal allowances (e.g., traffic regulations allowing autonomous driving, noise allowance allowing for aerial vehicles, etc.), operational capabilities of the autonomous vehicle, and/or any other factor that can affect the safe operation of the autonomous vehicle within a particular environment.

By way of example, in some implementations, an autonomous vehicle can be associated with one or more operational capabilities. As an example, the autonomous vehicle can be associated with operational capability(s) based, at least in part, on a fleet of autonomous vehicles corresponding to the autonomous vehicle. For example, each of the one or more fleets of vehicles can be associated with a set of operational capabilities. In some implementations, the operational capabilities of each vehicle in a respective fleet of vehicles can correspond to the set of operational capabilities associated with the respective fleet of vehicles. The operational capabilities of a vehicle and/or a fleet can indicate the capabilities (e.g., autonomy capabilities, etc.) the vehicle/fleet is able to perform, the capabilities the vehicle/fleet are unable to perform, areas in which the vehicle/fleet are able and/or permitted to operate, areas in which the vehicle/fleet are unable and/or restricted from operating, etc. For instance, the operational capabilities of an autonomous vehicle can be indicative of one or more vehicle maneuvers, speeds, turning angles, or any other movement that the autonomous vehicle can reliably perform on a roadway. In addition, or alternatively, the operational capabilities of an autonomous vehicle can be indicative of one or more geographic and/or timing permissions/restrictions due to weather conditions, lighting conditions, traffic regulation, and/or any other factor that can contribute to the reliable performance of the autonomous vehicle.

To ensure safe operation, an autonomous vehicle can be configured to operate within one or more approved areas of a travel way network. An approved area of a travel way network can be identified by an operational domain. An operational domain can include a complete set of external conditions under which an autonomous vehicle is approved for use (e.g., operation on public roads, certain sky lanes, etc.) in a self-driving mode. As an example, an operational domain can be indicative of one or more operational travel way segments of a plurality of travel way segments of a travel way network. An operational domain can be determined for one or more autonomous vehicles (e.g., of a fleet of autonomous vehicles, etc.) based, at least in part, on approval criteria defined by the service entity. The approval criteria, for example, can be defined based, at least in part, on policies of the service entity.

More particularly, the operations computing system (e.g., a backend operational domain service) of the service entity can generate one or more operational domains for a travel way network based, at least in part, on map data representative of the travel way network and operational domain parameters. For example, the operations computing system can include one or more computing devices remote from one or more autonomous vehicles. The operations computing system can include one or more communication interfaces communicatively connected to the one or more autonomous vehicles. In some implementations, as described in further detail herein, the operations computing system can include one or more display devices. The display device(s) can be configured to present one or more user interfaces configured to display map and/or autonomous vehicle information. In some implementations, a user can interact with the one or more user interfaces to provide user input data (e.g., a query, etc.) to the operations computing system.

The operations computing system can obtain map data associated with the travel way network including a plurality of travel way segments. The map data can include a plurality of segment attributes for each travel way segment of the plurality of travel way segments. The plurality of segment attributes for a respective travel way segment can be indicative of one or more speed limits, road grades, lane widths, traffic signs, turn radiuses, vehicle maneuvers, and/or any other characteristic of a travel way segment. For example, the map data can include a plurality of high fidelity tags, each tag describing an attribute or characteristic of a travel way segment. The high fidelity tags can characterize all infrastructure of a travel way network including traffic lane widths, the presence (and/or absence) of an unprotected left turn, speed limits (and/or changes thereof), road grades, etc. In some implementations, the high fidelity tags can be generated (e.g., automatically based, at least in part, on one or more rules-based techniques, manually, etc.) based, at least in part, on one or more policies of the service entity (and/or third-party map distributor). In some implementations, the map data can include the same map data utilized by an autonomous vehicle for perceiving and navigating its environment. The map data can include multiple versions. Each map version can be descriptive of an updated set of segment attributes and/or road segments for a travel way network.

In addition, or alternatively, the operations computing system can obtain one or more operational domain parameters for the plurality of travel way segments. The one or more operational domain parameters can be indicative of a range of acceptable values for the plurality of segment attributes for each travel way segment of the plurality of travel way segments. As an example, the range of acceptable values can include an acceptable road grade range for a road grade segment attribute between negative ten percent to positive ten percent. As another example, the range of acceptable values can include an acceptable unprotected left turn range for an unprotected left turn segment attribute of “no” (e.g., indicating that the road segment does include an unprotected left turn). In this manner, the range of acceptable values can designate any number of different values as acceptable for each of the plurality of road segment attributes.

The one or more operational domain parameters can be based, at least in part, on approval criteria associated with one or more operational capabilities of a fleet of autonomous vehicles. The approval criteria, for example, can include one or more safety, legal, and/or performance considerations associated with the service entity. For instance, the approval criteria can include one or more operational protocols, one or more environment protocols, and/or one or more travel way protocols associated with the fleet of autonomous vehicles and/or the service entity. The one or more operational protocols can be indicative of one or more restricted vehicle maneuvers (e.g., unprotected left turns, speed limit thresholds, etc.), the one or more environment protocols can be indicative of one or more restricted operating environments of the travel way network (e.g., weather conditions, lighting conditions, etc.), and the one or more travel way protocols can be indicative of one or more preferred segment attributes (e.g., a preferred road width, lane width, sky lane width, road grade, etc.).

At least one of the one or more operational protocols, the one or more environment protocols, or the one or more travel way protocols can be based, at least in part, on the one or more operational capabilities associated with the fleet of autonomous vehicles. By way of example, an autonomous vehicle's operational capabilities can identify a reduction in performance when traversing travel way segments with road grades below negative ten percent and/or above positive ten percent. In such a case, the operational protocols can include a requirement to constrain an operational domain to travel way segments within a particular range of road grades. As another example, an autonomous vehicle's operational capabilities can identify an inability to safely perform an unprotected left turn. In such a case, the operational protocol(s) can include a requirement restricting an unprotected left turn. As an example, the operational protocols can include a requirement for a travel way segment to have a “No” value for any unprotected left turn attribute.

The operational domain parameter(s) can be determined and/or obtained by the operations computing system. For example, the operations computing system can obtain user input comprising the operational domain parameter(s). For instance, the operations computing system can present, via one or more display devices, a user query interface indicative of a plurality of potential travel way segment attributes. A user can interact with the user query interface to input a domain query including the operational domain parameter(s). In this manner, the operations computing system can obtain, from the user via a user interface, a domain query including the operational domain parameter(s). In some implementations, the operations computing system can generate an initial operational domain and continuously update the initial operational domain in response to receiving interaction data indicative of new and/or changes to the operational domain parameters (e.g., as the user interacts with the user query interface).

In addition, or alternatively, the operations computing system can be configured to automatically generate the operational domain parameters based, at least in part, on one or more service entity policies. For example, the operations computing system can determine the range of acceptable values (e.g., as identified by the operational domain parameters) based, at least in part, on at least one of the one or more operational protocols, the one or more environment protocols, and/or the one or more travel way protocols. In some implementations, the operational domain parameters can be modified based, at least in part, on one or more risk thresholds defining acceptable risks to passenger convenience relative to a desired reach of an autonomous vehicle. For instance, each value (e.g., road grade values of a road grade attribute) of the plurality of travel way segment attributes can be associated with risk value indicating an impact of the respective value on transportation desirability (e.g., a high road grade value can be less desirable for transportation, etc.). In such a case, the operations computing system can be configured to automatically modify operational domain parameters to accommodate for risk threshold(s) identified by a service entity.

In some implementations, the operational domain parameters can be determined based, at least in part, on a performance threshold. The performance threshold, for example, can identify a desired ride quality for an autonomous vehicle. The desired ride quality can identify a desired level of passenger comfort for a passenger of the autonomous vehicle. The performance threshold can be determined based, at least in part, on the one or more service entity policies and/or rider input. For example, in some implementations, the operations computing system can obtain a performance threshold associated with an autonomous vehicle. As an example, the performance threshold can be associated with a rider of a ride-sharing service offered by the service entity. In such a case, the performance threshold can include a desired ride quality (e.g., as measured by sliding scale such as a one to five star rating system, etc.) identified by the rider (e.g., via a mobile device, etc. associated with the rider). The operations computing system can generate the operational domain parameters based, at least in part, on the one or more of the one or more travel way protocols, safety protocols, or policy protocols associated with the fleet of autonomous vehicles and the performance threshold associated with the autonomous vehicle. As an example, an operational domain parameter associated with a vehicle speed can be increased within limitations prescribed by travel way protocols or safety protocols (e.g., speed limits, etc.) in accordance with a lower performance threshold and reduced in accordance with a higher performance threshold. In this manner, a rider of an autonomous vehicle can have input on the balance between speed and rider convenience.

The operations computing system can generate an operational domain for the fleet of autonomous vehicles based, at least in part, on the map data and the one or more operational domain parameters. Each operational domain can be associated with a respective set of operational domain parameters corresponding to the operational domain. The operational domain can be indicative of one or more operational travel way segments of the plurality of travel way segments of a travel way network. The plurality of segment attributes for each of the one or more operational travel way segments can achieve each of the one or more operational domain parameters (e.g., of the set of operational domain parameters corresponding to the operational domain). For example, the operations computing system can compare each of the plurality of segment attributes for each of the plurality of travel way segments to a corresponding operational domain parameter (e.g., a road grade attribute compared to an operational domain parameter indicative of an acceptable range of road grades, etc.). The operations computing system can filter out any non-conforming travel way segment of the travel way network from the operational domain. A non-conforming travel way segment, for example, can be associated with a segment attribute that does not achieve a corresponding operational domain parameter.

In some implementations, the operations computing system can generate one or more operational domains for a fleet of autonomous vehicles based, at least in part, on the map data and the operational parameter(s). The operational travel way segments of the operational domain(s) can include one or more disconnected operational travel way segments and/or one or more connected operational travel way segments. The operational domain(s), for example, can include a connected operational domain indicative of the one or more connected operational travel way segments and/or a disconnected operational domain indicative of the one or more connected operational travel way segments and the one or more disconnected operational travel way segments.

The operational domain(s) can include one or more manual inclusions and/or exclusions. For instance, the operations computing system can provide for display, via the one or more display devices, a map interface indicative of the travel way network, the one or more connected operational travel way segments, and/or the one or more disconnected operational travel way segments. The map interface can include a plurality of interactive travel way segments identifying the one or more connected operational travel way segments and/or the one or more disconnected operational travel way segments. The operations computing system can obtain, via the map interface, user input indicative of an interactive travel way segment of the plurality of interactive travel way segments and, in response to the user input, provide for display, via the map interface, a plurality of respective segment attributes for a respective travel way segment corresponding to the interactive travel way segment.

In addition, the user input can be indicative of a manual inclusion and/or exclusion of a travel way segment to an operational domain. For example, a user can analyze the map interface (and/or the operational domain presented by the map interface) to determine one or more additional operational travel way segments or one or more nonconforming travel way segments of the operational domain. The map interface can include one or more interface tools (e.g., a drawing tool, selection tool, etc.) usable by the user to identify the additional operational travel way segment(s) and/or nonconforming travel way segment(s). For instance, a user can select an operational travel way segment and change its status to nonoperational to identify a nonconforming operational travel way segment. In addition, the user can select a nonconforming travel way segment and change its status to operational to identify an additional operational travel way segment. After review, the user can submit the operational domain for approval.

The operations computing system can generate verification data for the operational domain based, at least in part, on one or more comparisons between the operational domain and the approval criteria. For example, the operational domain can be created based, at least in part, on operational domain parameters that are generated based, at least in part, on the approval criteria. The verification data can be indicative of a verification that the resulting operational domain (and/or the parameters used to generate the operational domain) satisfy the approval criteria. In some implementations, the operational domain can be verified during a two-step procedure. During the first step, the operational domain can be verified with respect to any manual inclusions to the operational domain. During the second step, the operational domain can be verified with respect to each operational travel way segment of the operational domain.

To do so, the operations computing system can obtain domain characteristics corresponding to the operational domain. The domain characteristics can identify the operational domain parameters, one or more manual travel way segment inclusions to the operational domain, and/or the plurality of segment attributes for each of the one or more operational travel way segments. The operations computing system can generate the verification data for the operational domain based, at least in part, on the domain characteristics and the one or more operational protocols, the one or more environment protocols, and/or the one or more travel way protocols.

In some implementations, the verification data can be generated based, at least in part, on a domain risk. For example, the operations computing system can determine a domain risk for the operational domain based, at least in part, on the plurality of segment attributes associated with each operational travel way segment of the operational domain and/or the one or more operational domain parameters used to generate the operational domain. The operations computing system can automatically and/or manually verify the operational domain based, at least in part, on a comparison between the domain risk and the one or more risk threshold associated with the service entity. For example, in some implementations, the operations computing system can automatically verify the operational domain in the event that the domain risk is lower than a risk threshold associated with the service entity. In addition, or alternatively, the operations computing system can provide the operational domain to a user for manual verification in the event that the domain risk is higher than a risk threshold associated with the service entity.

The operations computing system can determine that at least one travel way segment of the one or more operational travel way segments of the operational domain fails to achieve the approval criteria. In such a case, the operations computing system can generate verification data indicative of a failed operational domain, the at least one travel way segment, and/or the approval criteria. For example, the verification data can identify the approval criteria that is violated by the at least on travel way segment.

In addition, or alternatively, the operations computing system can generate the verification data in response to determining that each of the one or more operational travel way segments of the operational domain achieve the approval criteria. The verification data can include a cryptographic validation signature indicative of a validated operational domain. The cryptographic validation signature can include one or more cryptographic signature(s) implemented one or more cryptographic signing techniques such as, for example, asymmetric and/or symmetric signing processes. By way of example, the verification data can include an operational domain signed in accordance with one or more cryptographic signing techniques. The signed operational domain can be indicative of a user's approval of the operational domain and/or the operations computing system's approval of the operation domain for use.

The operations computing system can provide travel way network data indicative of at least one of the one or more operational domains to an autonomous vehicle of the fleet of autonomous vehicles. For instance, the operations computing system can determine an operation type associated with the autonomous vehicle. The operation type, for example, can identify whether the autonomous vehicle is associated with a vehicle operator (e.g., whether the vehicle is operated, supervised, etc. by a vehicle operator). The operations computing system can determine the travel way network data for the autonomous vehicle based, at least in part, on the one or more operational domain(s) and the operation type. For example, the operations computing system can provide travel way network data indicative of the connected operational domain to the autonomous vehicle in the event that the operation type is not indicative of a vehicle operator. In addition, or alternatively, the operations computing system can provide travel way network data indicative of the disconnected operational domain to the autonomous vehicle in the event that the operation type is indicative of a supervisory vehicle operator.

In addition, or alternatively, the operations computing system can provide the operational domain to the autonomous vehicle based, at least in part, on the verification data. For instance, the operations computing system can provide the operational domain to an autonomous vehicle in response to determining that each of the one or more operational travel way segments of the operational domain achieve the approval criteria. In some implementations, the operations computing system can provide, to the autonomous vehicle, data indicative of the operational domain signed by the cryptographic validation signature. In such a case, the autonomous vehicle can be configured to verify the cryptographic validation signature before traversing the travel way network based, at least in part, on the operational domain. In this manner, an autonomous vehicle can ensure vehicle safety by validating that an operational domain has been correctly authorized for use by the operations computing system and/or user thereof.

The travel way network data can be indicative of an operational domain and/or a current routable network (e.g., a subset of the operational domain updated based, at least in part, on real-time data). For example, in some implementations, the operations computing system can generate a current routable network based, at least in part, on the operational domain and real-time travel way data. For instance, the current routable travel way network can be generated in response to determining that each of the one or more operational travel way segments of the operational domain achieve the approval criteria. In this manner, a current routable network can be only generated for verified operational domains. In addition, or alternatively, the operations computing system can obtain selection data indicative of a selected operational domain of the one or more operational domains. In such a case, the current routable network can be generated for a selected operational domain. The current routable travel way network can be indicative of a subset of the one or more operational travel way segments (e.g., of the verified and/or selected operational domain).

More particularly, the operations computing system can obtain real-time travel way data associated with the operational travel way segment(s) of the operational domain (e.g., selected, verified, etc.). The real-time travel way data can be indicative of temporary travel way (e.g., road, etc.) conditions associated with the one or more operational travel way segments. As an example, the temporary travel way conditions can be indicative of one or more travel way defects (e.g., potholes, etc.), travel way maintenance events (e.g., construction, etc.), or travel way closures (e.g., due to events such as parades, etc.). The operations computing system can generate the current routable travel way network for the fleet of autonomous vehicles based, at least in part, on the operational domain (e.g., selected, verified, etc.) and the real-time travel way data.

As an example, the operations computing system can determine one or more operational constraints for the operational domain based, at least in part, on the temporary travel way conditions. The current routable travel way network can be generated based, at least in part, on the operational domain and the one or more operational constraints. For instance, the one or more operational constraints can be indicative of one or more restricted travel way segments of the one or more operational travel way segments due to the temporary travel way conditions. In such a case, the current routable travel way network can be indicative of a subset of the one or more operational travel way segments.

The operational constraints can be manually applied (e.g., via one or more selector tools of the map interface) and/or automatically determined based, at least in part, on the real-time travel way data. For example, the operational constraints can be determined based, at least in part, on sensor data (and/or other traffic related data) indicative of travel way closures. As an example, an operational constraint indicative of a restrictive travel way segment can be determined in response to image data representing construction (e.g., a pattern of orange construction cones, etc.) proximate to the restricted travel way segment.

In some implementations, the operations computing system can be configured to continuously update an operational domain by generating an updated current routable network based, at least in part, on updated real-time travel way data. For example, the operations computing system can obtain updated real-time travel way data associated with the one or more operational travel way segments of the operational domain (e.g., selected, verified, etc.). The updated real-time travel way data can be obtained at a time subsequent to the real-time travel way data. In some implementations, the updated real-time travel way data can be obtained from the autonomous vehicle. For example, the autonomous vehicle can obtain sensor data (e.g., image data, etc.) indicative of the real-time travel way data as the autonomous vehicle traverses the travel way network. The sensor data, for example, can include three dimensional data points (e.g., LiDAR data, image data, etc.) descriptive of one or more traffic cones (e.g., indicative of a construction events, etc.), barriers (e.g., indicative of travel way closures, etc.), crowds (e.g., indicative of parades, etc.), and/or any other information associated with the surrounding environment that identifies a travel way condition (e.g., travel way closure, etc.). The operations computing system can obtain data indicative of the sensor data (e.g., the sensor data and/or one or more determinations made based, at least in part, on the sensor data) and update one or more statuses of the plurality of travel way segments within the travel way network based, at least in part, on the data. The operations computing system can generate the updated current routable travel way network for the autonomous vehicle based, at least in part, on the selected and/or verified operational domain and the updated real-time travel way data.

In some implementations, the current routable travel way network can be generated by a proxy vehicle computing system remote from the fleet of autonomous vehicles based, at least in part, on the real-time travel way data, the operational domain, and/or the map data. For example, the proxy vehicle computing system can include a remote service (e.g., running on the operations computing system) configured to mirror the operations of a vehicle computing system onboard an autonomous vehicle. The proxy vehicle computing system can be configured to simulate the operations of an autonomous vehicle based, at least in part, on simulated data indicative of an operating environment. The proxy vehicle computing system can receive the real-time travel way data, the operational domain, and/or the map data as inputs and, in response, generate a proxy vehicle cryptographic signature for the current routable travel way network. The current routable network can be signed by the proxy vehicle cryptographic signature (e.g., via one or more cryptographic signing techniques) to validate the current routable travel way network before deployment.

The operations computing system can provide travel way network data indicative of the current routable network (and/or the updated current routable network) to the autonomous vehicle for use in traversing the travel way network. For example, the operations computing system can provide, to the autonomous vehicle, data indicative of the current routable travel way network signed by the cryptographic validation signature and the proxy vehicle cryptographic signature. For example, the operations computing system can select an autonomous vehicle from the fleet(s) of autonomous vehicles, determine map data associated with the selected vehicle (e.g., a map version used by the autonomous vehicle), select an operational domain based, at least in part, on the map data (e.g., an operational domain generated using the determined map version), select an operational constraint set for the operation domain, generate the current routable network for the vehicle based, at least in part, on the operational domain and the operational constraint set, provide the current routable network to the vehicle for use in traversing the travel way network.

In some implementations, the operations computing system can be configured to present, via one or more display devices, a deployment user interface. The deployment user interface can include one or more selector widgets for assigning an operational domain and/or current routable network to an autonomous vehicle. For example, the selector widgets can include an autonomous vehicle selector widget for use in selecting an autonomous vehicle. In addition, the selector widgets can include a map selector widget for use in selecting a map version. The map selector widget, in some implementations, can be configured to automatically down select based, at least in part, on a map version associated with the autonomous vehicle. In addition, the selector widgets can include an operational domain selector widget for use in selecting an operational domain. The operational domain selector widget, in some implementations, can be configured to automatically down select based, at least in part, on the operational domains associated with the selected map version. In addition, the selector widgets can include an operational constraint set selector widget for use in selecting an operational constraint set to be applied to the operational domain. The operational constraint set selector widget, in some implementations, can be configured to automatically down select based, at least in part, on the operational constraint sets associated with the selected map version. In this manner, the selector widgets can ensure compatibility between the autonomous vehicle and each component of a current routable network.

In some implementations, the operations computing system can be configured to track the autonomous vehicle. For instance, the operations computing system can obtain vehicle data indicative of a location of the autonomous vehicle. In some implementations, the operations computing system can provide for display, via one or more display devices, a map interface indicative of the travel way network, the current routable travel way network for the autonomous vehicle, and/or the location of the autonomous vehicle. For example, this can be done for every vehicle in the one or more fleets of vehicles associated with the service entity. The map interface can include interactive vehicles. For instance, in response to the selection of an interactive vehicle, the map interface can be configured to represent the vehicle's location, on active operation domain of the vehicle, an active current routable network of the vehicle, etc.

The systems and methods described herein provide a number of technical effects and benefits. More particularly, the systems and methods of the present disclosure provide improved techniques for generating, verifying, and validating an operational domain for a fleet of autonomous vehicles. For instance, a service entity can include a number of transportation policies that can define risk thresholds acceptable to the service entity. The transportation policies can be represented by approval criteria identifying restrictions on the use of autonomous vehicles due to legal, policy, and/or autonomous capability considerations. The computing system of the present disclosure can utilize a tiered generation, verification, selection, and approval approach to ensure the validity of an operational domain defining the boundaries of an autonomous vehicle's operation within a travel way network before the operational domain is used for navigation by the autonomous vehicle. In this way, the computing system can provide a practical improvement to autonomous vehicle safety by verifying the selection of operational domains compatible to vehicles and/or real-time circumstances.

Example aspects of the present disclosure can provide a number of improvements to computing technology such as, for example, autonomous vehicle computing technology. For instance, the systems and methods of the present disclosure can provide an improved approach for vehicle motion planning. For example, a system can obtain map data associated with a travel way network including a plurality of travel way segments. The system can obtain one or more operational domain parameters for the plurality of travel way segments and generate an operational domain for a fleet of autonomous vehicles based, at least in part, on the map data and the one or more operational domain parameters. The system can generate verification data for the operational domain based, at least in part, on one or more comparisons between the operational domain and approval criteria. And, the system can provide the operational domain to an autonomous vehicle of the fleet of autonomous vehicles based, at least in part, on the verification data.

In this manner, the computing system can employ improved authorization, verification, and cryptographic signing techniques to ensure vehicle and passenger safety. To this end, the computing system can accumulate and utilize newly available information such as, for example, approval criteria, operational parameters, operational constraints, etc. The approval criteria can be uniquely tailored to autonomous vehicle capability of an autonomous vehicle and policies defined by a service entity. The computing system can implement rules-based techniques for utilizing the approval criteria in a tiered approval process designed to verify and validate an operational domain before deployment on a travel way. In this way, the computing system provides a practical application that improves autonomous vehicle safety by verifying the operational travel way segments designated as operable for autonomous navigation.

Moreover, the operational capabilities of an autonomous vehicle can change overtime (e.g., with improvements in hardware, new software releases, etc.). The technology of the present disclosure can allow an associated entity to more efficiently and preemptively account for these changes in the corresponding vehicle position, routing, and deployment. This can allow for more efficient use of the autonomous vehicle's onboard resources because its operational domain can be updated to reflect its current operational capabilities.

Various means can be configured to perform the methods and processes described herein. For example, a computing system can include data obtaining unit(s), operational domain unit(s), verification unit(s), data providing unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s), etc.) can be configured to obtain map data associated with a travel way network including a plurality of travel way segments. The map data can include a plurality of segment attributes for each travel way segment of the plurality of travel way segments. In addition, or alternatively, the means (e.g., data obtaining unit(s), etc.) can be configured to obtain one or more operational domain parameters for the plurality of travel way segments. The one or more operational domain parameters can be based, at least in part, on approval criteria associated with one or more operational capabilities of a fleet of autonomous vehicles.

The means (e.g., operational domain unit(s), etc.) can be configured to generate an operational domain for the fleet of autonomous vehicles based, at least in part, on the map data and the one or more operational domain parameters. The operational domain can be indicative of one or more operational travel way segments of the plurality of travel way segments. The means (e.g., verification unit(s), etc.) can be configured to generate verification data for the operational domain based, at least in part, on one or more comparisons between the operational domain and the approval criteria. And, the means (e.g., data providing unit(s), etc.) can be configured to provide the operational domain to an autonomous vehicle of the fleet of autonomous vehicles based, at least in part, on the verification data. The autonomous vehicle can be configured to traverse the travel way network based, at least in part, on the operational domain.

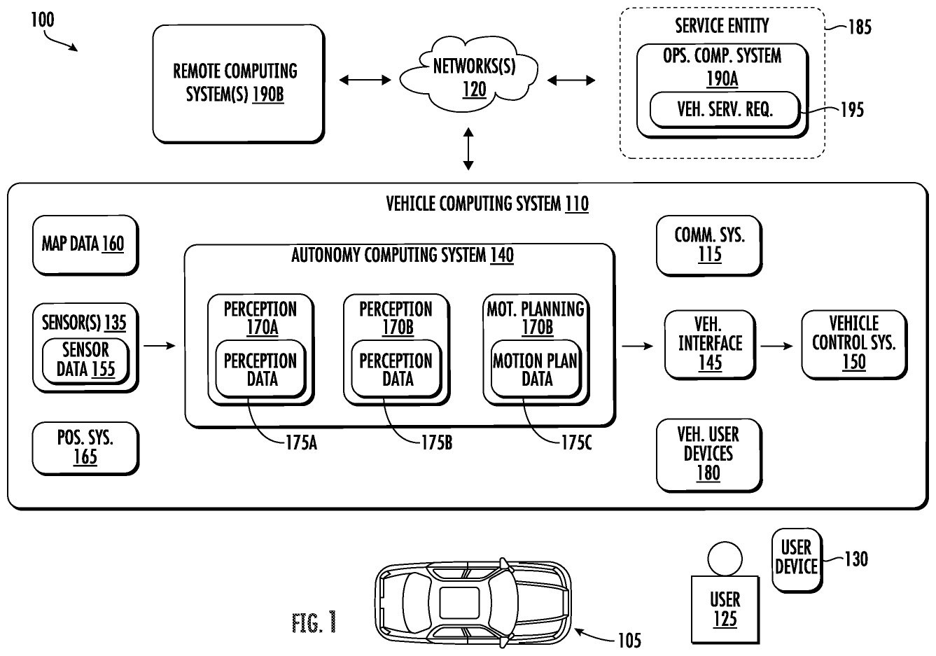

With reference now to FIGS. 1-10, example implementations of the present disclosure will be discussed in further detail. FIG. 1 depicts a block diagram of an example system 100 for controlling and communicating with a vehicle according to example aspects of the present disclosure. As illustrated, FIG. 1 shows a system 100 that can include a vehicle 105 and a vehicle computing system 110 associated with the vehicle 105. The vehicle computing system 100 can be located onboard the vehicle 105 (e.g., it can be included on and/or within the vehicle 105).

The vehicle 105 incorporating the vehicle computing system 100 can be various types of vehicles. For instance, the vehicle 105 can be an autonomous vehicle. The vehicle 105 can be a ground-based autonomous vehicle (e.g., car, truck, bus, etc.). The vehicle 105 can be an air-based autonomous vehicle (e.g., airplane, helicopter, vertical take-off and lift (VTOL) aircraft, etc.). The vehicle 105 can be a lightweight elective vehicle (e.g., bicycle, scooter, etc.). The vehicle 105 can be any other type of vehicle (e.g., watercraft, etc.). The vehicle 105 can drive, navigate, operate, etc. with minimal and/or no interaction from a human operator (e.g., driver, pilot, etc.). In some implementations, a human operator can be omitted from the vehicle 105 (and/or also omitted from remote control of the vehicle 105). In some implementations, a human operator can be included in the vehicle 105.

The vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a human operator present in the vehicle 105 and/or remote from the vehicle 105). The vehicle 105 can operate in a semi-autonomous operating mode in which the vehicle 105 can operate with some input from a human operator present in the vehicle 105 (and/or a human operator that is remote from the vehicle 105). The vehicle 105 can enter into a manual operating mode in which the vehicle 105 is fully controllable by a human operator (e.g., human driver, pilot, etc.) and can be prohibited and/or disabled (e.g., temporary, permanently, etc.) from performing autonomous navigation (e.g., autonomous driving, flying, etc.). The vehicle 105 can be configured to operate in other modes such as, for example, park and/or sleep modes (e.g., for use between tasks/actions such as waiting to provide a vehicle service, recharging, etc.). In some implementations, the vehicle 105 can implement vehicle operating assistance technology (e.g., collision mitigation system, power assist steering, etc.), for example, to help assist the human operator of the vehicle 105 (e.g., while in a manual mode, etc.).

To help maintain and switch between operating modes, the vehicle computing system 110 can store data indicative of the operating modes of the vehicle 105 in a memory onboard the vehicle 105. For example, the operating modes can be defined by an operating mode data structure (e.g., rule, list, table, etc.) that indicates one or more operating parameters for the vehicle 105, while in the particular operating mode. For example, an operating mode data structure can indicate that the vehicle 105 is to autonomously plan its motion when in the fully autonomous operating mode. The vehicle computing system 110 can access the memory when implementing an operating mode.

The operating mode of the vehicle 105 can be adjusted in a variety of manners. For example, the operating mode of the vehicle 105 can be selected remotely, off-board the vehicle 105. For example, a remote computing system (e.g., of a vehicle provider and/or service entity associated with the vehicle 105) can communicate data to the vehicle 105 instructing the vehicle 105 to enter into, exit from, maintain, etc. an operating mode. By way of example, such data can instruct the vehicle 105 to enter into the fully autonomous operating mode.

In some implementations, the operating mode of the vehicle 105 can be set onboard and/or near the vehicle 105. For example, the vehicle computing system 110 can automatically determine when and where the vehicle 105 is to enter, change, maintain, etc. a particular operating mode (e.g., without user input). Additionally, or alternatively, the operating mode of the vehicle 105 can be manually selected via one or more interfaces located onboard the vehicle 105 (e.g., key switch, button, etc.) and/or associated with a computing device proximate to the vehicle 105 (e.g., a tablet operated by authorized personnel located near the vehicle 105). In some implementations, the operating mode of the vehicle 105 can be adjusted by manipulating a series of interfaces in a particular order to cause the vehicle 105 to enter into a particular operating mode.

The vehicle computing system 110 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein for navigating within a travel network, etc.

The vehicle 105 can include a communications system 115 configured to allow the vehicle computing system 110 (and its computing device(s)) to communicate with other computing devices. The communications system 115 can include any suitable components for interfacing with one or more network(s) 120, including, for example, transmitters, receivers, ports, controllers, antennas, and/or other suitable components that can help facilitate communication. In some implementations, the communications system 115 can include a plurality of components (e.g., antennas, transmitters, and/or receivers) that allow it to implement and utilize multiple-input, multiple-output (MIMO) technology and communication techniques.

The vehicle computing system 110 can use the communications system 115 to communicate with one or more computing device(s) that are remote from the vehicle 105 over one or more networks 120 (e.g., via one or more wireless signal connections). The network(s) 120 can exchange (send or receive) signals (e.g., electronic signals), data (e.g., data from a computing device), and/or other information and include any combination of various wired (e.g., twisted pair cable) and/or wireless communication mechanisms (e.g., cellular, wireless, satellite, microwave, and radio frequency) and/or any desired network topology (or topologies). For example, the network(s) 120 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communication network (or combination thereof) for transmitting data to and/or from the vehicle 105 and/or among computing systems.

In some implementations, the communications system 115 can also be configured to enable the vehicle 105 to communicate with and/or provide and/or receive data and/or signals from a remote computing device associated with a user 125 and/or an item (e.g., an item to be picked-up for a courier service). For example, the communications system 115 can allow the vehicle 105 to locate and/or exchange communications with a user device 130 of a user 125. In some implementations, the communications system 115 can allow communication among one or more of the system(s) on-board the vehicle 105.

As shown in FIG. 1, the vehicle 105 can include one or more sensors 135, an autonomy computing system 140, a vehicle interface 145, one or more vehicle control systems 150, and other systems, as described herein. One or more of these systems can be configured to communicate with one another via one or more communication channels. The communication channel(s) can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel(s).

The sensor(s) 135 can be configured to acquire sensor data 155. The sensor(s) 135 can be external sensors configured to acquire external sensor data. This can include sensor data associated with the surrounding environment of the vehicle 105. The surrounding environment of the vehicle 105 can include/be represented in the field of view of the sensor(s) 135. For instance, the sensor(s) 135 can acquire image and/or other data of the environment outside of the vehicle 105 and within a range and/or field of view of one or more of the sensor(s) 135. The sensor(s) 135 can include one or more Light Detection and Ranging (LIDAR) systems, one or more Radio Detection and Ranging (RADAR) systems, one or more cameras (e.g., visible spectrum cameras, infrared cameras, etc.), one or more motion sensors, one or more audio sensors (e.g., microphones, etc.), and/or other types of imaging capture devices and/or sensors. The one or more sensors can be located on various parts of the vehicle 105 including a front side, rear side, left side, right side, top, and/or bottom of the vehicle 105. The sensor data 155 can include image data (e.g., 2D camera data, video data, etc.), RADAR data, LIDAR data (e.g., 3D point cloud data, etc.), audio data, and/or other types of data. The vehicle 105 can also include other sensors configured to acquire data associated with the vehicle 105. For example, the vehicle 105 can include inertial measurement unit(s), wheel odometry devices, and/or other sensors.

In some implementations, the sensor(s) 135 can include one or more internal sensors. The internal sensor(s) can be configured to acquire sensor data 155 associated with the interior of the vehicle 105. For example, the internal sensor(s) can include one or more cameras, one or more infrared sensors, one or more motion sensors, one or more weight sensors (e.g., in a seat, in a trunk, etc.), and/or other types of sensors. The sensor data 155 acquired via the internal sensor(s) can include, for example, image data indicative of a position of a passenger or item located within the interior (e.g., cabin, trunk, etc.) of the vehicle 105. This information can be used, for example, to ensure the safety of the passenger, to prevent an item from being left by a passenger, confirm the cleanliness of the vehicle 105, remotely assist a passenger, etc.

In some implementations, the sensor data 155 can be indicative of one or more objects within the surrounding environment of the vehicle 105. The object(s) can include, for example, vehicles, pedestrians, bicycles, and/or other objects. The object(s) can be located in front of, to the rear of, to the side of, above, below the vehicle 105, etc. The sensor data 155 can be indicative of locations associated with the object(s) within the surrounding environment of the vehicle 105 at one or more times. The object(s) can be static objects (e.g., not in motion) and/or dynamic objects/actors (e.g., in motion or likely to be in motion) in the vehicle's environment. The sensor(s) 135 can provide the sensor data 155 to the autonomy computing system 140.

In addition to the sensor data 155, the autonomy computing system 140 can obtain map data 160. The map data 160 can provide detailed information about the surrounding environment of the vehicle 105 and/or the geographic area in which the vehicle was, is, and/or will be located. For example, the map data 160 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, and/or other traffic control devices); obstruction information (e.g., temporary or permanent blockages, etc.); event data (e.g., road closures/traffic rule alterations due to parades, concerts, sporting events, etc.); nominal vehicle path data (e.g., indicate of an ideal vehicle path such as along the center of a certain lane, etc.); and/or any other map data that provides information that assists the vehicle computing system 110 in processing, analyzing, and perceiving its surrounding environment and its relationship thereto. In some implementations, the map data 160 can include high definition map data. In some implementations, the map data 160 can include sparse map data indicative of a limited number of environmental features (e.g., lane boundaries, etc.). In some implementations, the map data can be limited to geographic area(s) and/or operating domains in which the vehicle 105 (or autonomous vehicles generally) may travel (e.g., due to legal/regulatory constraints, autonomy capabilities, and/or other factors).

The vehicle 105 can include a positioning system 165. The positioning system 165 can determine a current position of the vehicle 105. This can help the vehicle 105 localize itself within its environment. The positioning system 165 can be any device or circuitry for analyzing the position of the vehicle 105. For example, the positioning system 165 can determine position by using one or more of inertial sensors (e.g., inertial measurement unit(s), etc.), a satellite positioning system, based, at least in part, on IP address, by using triangulation and/or proximity to network access points or other network components (e.g., cellular towers, WiFi access points, etc.) and/or other suitable techniques. The position of the vehicle 105 can be used by various systems of the vehicle computing system 110 and/or provided to a remote computing system. For example, the map data 160 can provide the vehicle 105 relative positions of the elements of a surrounding environment of the vehicle 105. The vehicle 105 can identify its position within the surrounding environment (e.g., across six axes, etc.) based at least in part on the map data 160. For example, the vehicle computing system 110 can process the sensor data 155 (e.g., LIDAR data, camera data, etc.) to match it to a map of the surrounding environment to get an understanding of the vehicle's position within that environment. Data indicative of the vehicle's position can be stored, communicated to, and/or otherwise obtained by the autonomy computing system 140.

The autonomy computing system 140 can perform various functions for autonomously operating the vehicle 105. For example, the autonomy computing system 140 can perform the following functions: perception 170A, prediction 170B, and motion planning 170C. For example, the autonomy computing system 130 can obtain the sensor data 155 via the sensor(s) 135, process the sensor data 155 (and/or other data) to perceive its surrounding environment, predict the motion of objects within the surrounding environment, and generate an appropriate motion plan through such surrounding environment. In some implementations, these autonomy functions can be performed by one or more sub-systems such as, for example, a perception system, a prediction system, a motion planning system, and/or other systems that cooperate to perceive the surrounding environment of the vehicle 105 and determine a motion plan for controlling the motion of the vehicle 105 accordingly. In some implementations, one or more of the perception, prediction, and/or motion planning functions 170A, 170B, 170C can be performed by (and/or combined into) the same system and/or via shared computing resources. In some implementations, one or more of these functions can be performed via different sub-systems. As further described herein, the autonomy computing system 140 can communicate with the one or more vehicle control systems 150 to operate the vehicle 105 according to the motion plan (e.g., via the vehicle interface 145, etc.).

The vehicle computing system 110 (e.g., the autonomy computing system 140) can identify one or more objects within the surrounding environment of the vehicle 105 based at least in part on the sensor data 135 and/or the map data 160. The objects perceived within the surrounding environment can be those within the field of view of the sensor(s) 135 and/or predicted to be occluded from the sensor(s) 135. This can include object(s) not in motion or not predicted to move (static objects) and/or object(s) in motion or predicted to be in motion (dynamic objects/actors). The vehicle computing system 110 (e.g., performing the perception function 170C, using a perception system, etc.) can process the sensor data 155, the map data 160, etc. to obtain perception data 175A. The vehicle computing system 110 can generate perception data 175A that is indicative of one or more states (e.g., current and/or past state(s)) of one or more objects that are within a surrounding environment of the vehicle 105. For example, the perception data 175A for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape, object highlighting, etc.); class (e.g., pedestrian class vs. vehicle class vs. bicycle class, etc.), the uncertainties associated therewith, and/or other state information. The vehicle computing system 110 can utilize one or more algorithms and/or machine-learned model(s) that are configured to identify object(s) based at least in part on the sensor data 155. This can include, for example, one or more neural networks trained to identify object(s) within the surrounding environment of the vehicle 105 and the state data associated therewith. The perception data 175A can be utilized for the prediction function 175B of the autonomy computing system 140.

The vehicle computing system 110 can be configured to predict a motion of the object(s) within the surrounding environment of the vehicle 105. For instance, the vehicle computing system 110 can generate prediction data 175B associated with such object(s). The prediction data 175B can be indicative of one or more predicted future locations of each respective object. For example, the prediction system 175B can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175B can be indicative of the speed and/or acceleration at which the respective object is predicted to travel along its associated predicted motion trajectory. The vehicle computing system 110 can utilize one or more algorithms and/or machine-learned model(s) that are configured to predict the future motion of object(s) based at least in part on the sensor data 155, the perception data 175A, map data 160, and/or other data. This can include, for example, one or more neural networks trained to predict the motion of the object(s) within the surrounding environment of the vehicle 105 based at least in part on the past and/or current state(s) of those objects as well as the environment in which the objects are located (e.g., the lane boundary in which it is travelling, etc.). The prediction data 175B can be utilized for the motion planning function 170C of the autonomy computing system 140.

The vehicle computing system 110 can determine a motion plan for the vehicle 105 based at least in part on the perception data 175A, the prediction data 175B, and/or other data. For example, the vehicle computing system 110 can generate motion planning data 175C indicative of a motion plan. The motion plan can include vehicle actions (e.g., speed(s), acceleration(s), other actions, etc.) with respect to one or more of the objects within the surrounding environment of the vehicle 105 as well as the objects' predicted movements. The motion plan can include one or more vehicle motion trajectories that indicate a path for the vehicle 105 to follow. A vehicle motion trajectory can be of a certain length and/or time range. A vehicle motion trajectory can be defined by one or more way points (with associated coordinates). The planned vehicle motion trajectories can indicate the path the vehicle 105 is to follow as it traverses a route from one location to another. Thus, the vehicle computing system 110 can take into account a route/route data when performing the motion planning function 170C.

The motion planning system 180 can implement an optimization algorithm, machine-learned model, etc. that considers cost data associated with a vehicle action as well as other objective functions (e.g., cost functions based, at least in part, on speed limits, traffic lights, etc.), if any, to determine optimized variables that make up the motion plan. The vehicle computing system 110 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the vehicle computing system 110 can evaluate the predicted motion trajectories of one or more objects during its cost data analysis to help determine an optimized vehicle trajectory through the surrounding environment. The motion planning system 180 can generate cost data associated with such trajectories. In some implementations, one or more of the predicted motion trajectories and/or perceived objects may not ultimately change the motion of the vehicle 105 (e.g., due to an overriding factor). In some implementations, the motion plan may define the vehicle's motion such that the vehicle 105 avoids the object(s), reduces speed to give more leeway to one or more of the object(s), proceeds cautiously, performs a stopping action, passes an object, queues behind/in front of an object, etc.

The vehicle computing system 110 can be configured to continuously update the vehicle's motion plan and corresponding planned vehicle motion trajectories. For example, in some implementations, the vehicle computing system 110 can generate new motion planning data 175C/motion plan(s) for the vehicle 105 (e.g., multiple times per second, etc.). Each new motion plan can describe a motion of the vehicle 105 over the next planning period (e.g., next several seconds, etc.). Moreover, a new motion plan may include a new planned vehicle motion trajectory. Thus, in some implementations, the vehicle computing system 110 can continuously operate to revise or otherwise generate a short-term motion plan based, at least in part, on the currently available data. Once the optimization planner has identified the optimal motion plan (or some other iterative break occurs), the optimal motion plan (and the planned motion trajectory) can be selected and executed by the vehicle 105.

The vehicle computing system 110 can cause the vehicle 105 to initiate a motion control in accordance with at least a portion of the motion planning data 175C. A motion control can be an operation, action, etc. that is associated with controlling the motion of the vehicle 105. For instance, the motion planning data 175C can be provided to the vehicle control system(s) 150 of the vehicle 105. The vehicle control system(s) 150 can be associated with a vehicle interface 145 that is configured to implement a motion plan. The vehicle interface 145 can serve as an interface/conduit between the autonomy computing system 140 and the vehicle control systems 150 of the vehicle 105 and any electrical/mechanical controllers associated therewith. The vehicle interface 145 can, for example, translate a motion plan into instructions for the appropriate vehicle control component (e.g., acceleration control, brake control, steering control, etc.). By way of example, the vehicle interface 145 can translate a determined motion plan into instructions to adjust the steering of the vehicle 105 “X” degrees, apply a certain magnitude of braking force, increase/decrease speed, etc. The vehicle interface 145 can help facilitate the responsible vehicle control (e.g., braking control system, steering control system, acceleration control system, etc.) to execute the instructions and implement a motion plan (e.g., by sending control signal(s), making the translated plan available, etc.). This can allow the vehicle 105 to autonomously travel within the vehicle's surrounding environment.

The vehicle computing system 110 can store other types of data. For example, an indication, record, and/or other data indicative of the state of the vehicle (e.g., its location, motion trajectory, health information, etc.), the state of one or more users (e.g., passengers, operators, etc.) of the vehicle, and/or the state of an environment including one or more objects (e.g., the physical dimensions and/or appearance of the one or more objects, locations, predicted motion, etc.) can be stored locally in one or more memory devices of the vehicle 105. Additionally, the vehicle 105 can communicate data indicative of the state of the vehicle, the state of one or more passengers of the vehicle, and/or the state of an environment to a computing system that is remote from the vehicle 105, which can store such information in one or more memories remote from the vehicle 105. Moreover, the vehicle 105 can provide any of the data created and/or stored onboard the vehicle 105 to another vehicle.

The vehicle computing system 110 can include the one or more vehicle user devices 180. For example, the vehicle computing system 110 can include one or more user devices with one or more display devices located onboard the vehicle 105. A display device (e.g., screen of a tablet, laptop, and/or smartphone) can be viewable by a user of the vehicle 105 that is located in the front of the vehicle 105 (e.g., driver's seat, front passenger seat). Additionally, or alternatively, a display device can be viewable by a user of the vehicle 105 that is located in the rear of the vehicle 105 (e.g., a back passenger seat). The user device(s) associated with the display devices can be any type of user device such as, for example, a table, mobile phone, laptop, etc. The vehicle user device(s) 180 can be configured to function as human-machine interfaces. For example, the vehicle user device(s) 180 can be configured to obtain user input, which can then be utilized by the vehicle computing system 110 and/or another computing system (e.g., a remote computing system, etc.). For example, a user (e.g., a passenger for transportation service, a vehicle operator, etc.) of the vehicle 105 can provide user input to adjust a destination location of the vehicle 105. The vehicle computing system 110 and/or another computing system can update the destination location of the vehicle 105 and the route associated therewith to reflect the change indicated by the user input.

The vehicle 105 can be configured to perform vehicle services for one or a plurality of different service entities 185. A vehicle 105 can perform a vehicle service by, for example and as further described herein, travelling (e.g., traveling autonomously) to a location associated with a requested vehicle service, allowing user(s) and/or item(s) to board or otherwise enter the vehicle 105, transporting the user(s) and/or item(s), allowing the user(s) and/or item(s) to deboard or otherwise exit the vehicle 105, etc. In this way, the vehicle 105 can provide the vehicle service(s) for a service entity to a user.

A service entity 185 can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services. The vehicle services can be wholly performed by the vehicle 105 (e.g., travelling from the user/item origin to the ultimate destination, etc.) or performed by one or more vehicles and/or modes of transportation (e.g., transferring the user/item at intermediate transfer points, etc.).

An operations computing system 190A of the service entity 185 can help to coordinate the performance of vehicle services by autonomous vehicles. The operations computing system 190A can include and/or implement one or more service platforms of the service entity. The operations computing system 190A can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the operations computing system 190 (e.g., its one or more processors, etc.) to perform operations and functions, such as those described herein, for example, to generate, verify, authenticate operational domains, etc.

A user 125 can request a vehicle service from a service entity 185. For example, the user 125 can provide user input to a user device 130 to request a vehicle service (e.g., via a user interface associated with a mobile software application of the service entity 185 running on the user device 130). The user device 130 can communicate data indicative of a vehicle service request 195 to the operations computing system 190A associated with the service entity 185 (and/or another associated computing system that can then communicate data to the operations computing system 190A). The vehicle service request 195 can be associated with a user. The associated user can be the one that submits the vehicle service request (e.g., via an application on the user device 130). In some implementations, the user may not be the user that submits the vehicle service request. The vehicle service request can be indicative of the user. For example, the vehicle service request can include an identifier associated with the user and/or the user's profile/account with the service entity 185. The vehicle service request 195 can be generated in a manner that avoids the use of personally identifiable information and/or allows the user to control the types of information included in the vehicle service request 195. The vehicle service request 195 can also be generated, communicated, stored, etc. in a secure manner to protect information.

The vehicle service request 195 can indicate various types of information. For example, the vehicle service request 195 can indicate the type of vehicle service that is desired (e.g., a transportation service, a delivery service, a courier service, etc.), one or more locations (e.g., an origin location, a destination location, etc.), timing constraints (e.g., pick-up time, drop-off time, deadlines, etc.), and/or geographic constraints (e.g., to stay within a certain area, etc.). The service request 195 can indicate a type/size/class of vehicle such as, for example, a sedan, an SUV, luxury vehicle, standard vehicle, etc. The service request 195 can indicate a product of the service entity 185. For example, the service request 195 can indicate that the user is requesting a transportation pool product by which the user would potentially share the vehicle (and costs) with other users/items. In some implementations, the service request 195 can explicitly request for the vehicle service to be provided by an autonomous vehicle or a human-driven vehicle. In some implementations, the service request 195 can indicate a number of users that will be riding in the vehicle/utilizing the vehicle service. In some implementations, the service request 195 can indicate preferences/special accommodations of an associated user (e.g., music preferences, climate preferences, wheelchair accessibility, etc.) and/or other information.

The operations computing system 190A of the service entity 185 can process the data indicative of the vehicle service request 195 and generate a vehicle service assignment that is associated with the vehicle service request. The operations computing system can identify one or more vehicles that may be able to perform the requested vehicle services to the user 195. The operations computing system 190A can identify which modes of transportation are available to a user for the requested vehicle service (e.g., light electric vehicles, human-drive vehicles, autonomous vehicles, aerial vehicle, etc.) and/or the number of transportation modes/legs of a potential itinerary of the user for completing the vehicle service (e.g., single or plurality of modes, single or plurality of legs, etc.). For example, the operations computing system 190A can determined which autonomous vehicle(s) are online with the service entity 185 (e.g., available for a vehicle service assignment, addressing a vehicle service assignment, etc.) to help identify which autonomous vehicle(s) would be able to provide the vehicle service.

The operations computing system 190A and/or the vehicle computing system 110 can communicate with one or more other computing systems 190B that are remote from the vehicle 105. This can include, for example, computing systems associated with government functions (e.g., emergency services, regulatory bodies, etc.), computing systems associated with vehicle providers other than the service entity, computing systems of other vehicles (e.g., other autonomous vehicles, aerial vehicles, etc.). Communication with the other computing systems 190B can occur via the network(s) 120.

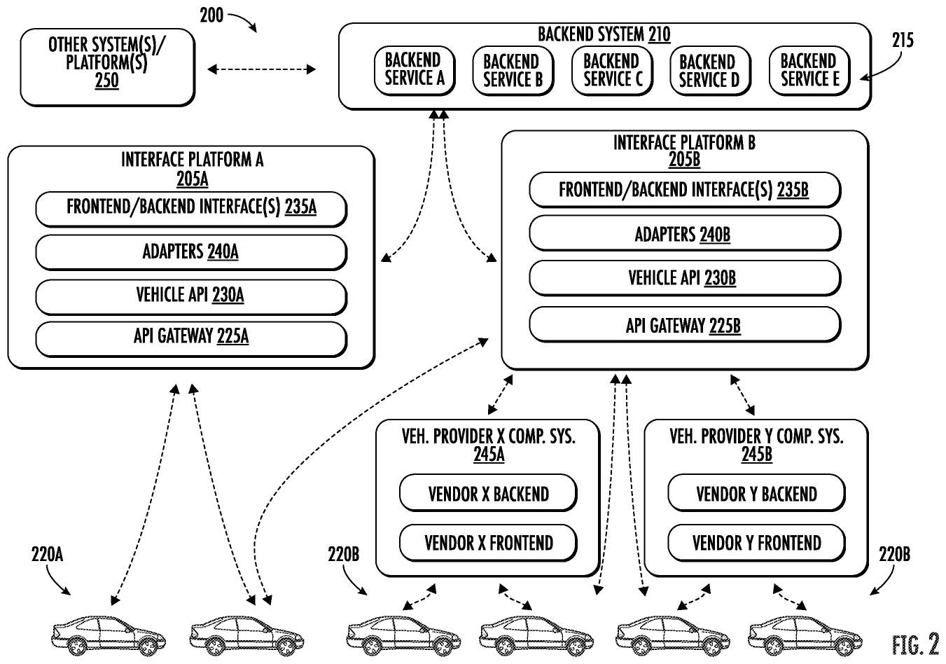

For example, FIG. 2 depicts an example service infrastructure 200 according to example implementations of the present disclosure. The service infrastructure 200 can include one or more systems, interfaces, and/or other components that can be included in an operations computing systems (e.g., operations computing system 190A) of the service entity (e.g., service entity 185) for coordinating vehicle services and managing/supporting the autonomous vehicle (e.g., autonomous vehicle 105) associated therewith. The service infrastructure 200 can represent, for example, the architecture of a service platform of the operations computing system for coordinating and providing one or more vehicle services (e.g., via autonomous vehicle(s), etc.).

The service infrastructure 200 of an operations computing system can include a first application programming interface platform 205A, a second application programming interface application platform 205B, and/or a backend system 210 with one or a plurality of backend services 215. These components can allow the service infrastructure 200 (e.g., the operations computing system) to communicate with one or more autonomous vehicles and/or one or more other systems.

The first application programming interface platform 205A can facilitate communication with one or more autonomous vehicles of the service entity. For example, as described herein, the service entity may own, lease, etc. a fleet of autonomous vehicles 220A that can be managed by the service entity (e.g., its backend services) to provide one or more vehicle services. The autonomous vehicle(s) 220A can be utilized by the service entity to provide the vehicle service(s) and can be included in the fleet of the service entity. Such autonomous vehicle(s) may be referred to as “service entity autonomous vehicles” or “first party autonomous vehicles.”

The first application programming interface platform 205A can include a number of components to help facilitate the support, coordination, and management of the first party autonomous vehicles 220A associated with the service entity. The first application programming interface platform 205A (e.g., a private platform, etc.) can provide access to one or more backend services 215 that are available to the first party autonomous vehicles 220A. To help do so, the first application programming interface platform 205A can include a first API gateway 225A. The first API gateway 225A can function as a proxy for application programming interface (API) calls and can help return an associated response. The first API gateway 225A can help provide other support functions for the service infrastructure 200 such as, for example, authentication functions, etc.

The first application programming interface platform 205A can include one or more APIs such as, for example, a first vehicle API 230A. The first vehicle API 230A can include a library and/or parameters for facilitating communications between the first party autonomous vehicles 220A and the backend service(s) 215 of the backend system 210. For example, the first vehicle API 230A can be called by a first party autonomous vehicle 220A and/or another system to help communicate data, messages, etc. to and/or from an autonomous vehicle. The first vehicle API 230A can provide for communicating such information in a secure, bidirectional manner that allows for expanded processing of data offboard a vehicle, analyzing such data in real time, and/or the like. The first API 230A may be referred to herein as a service entity API.

The first application programming interface platform 205A can include first frontend/backend interface(s) 235A. Each first frontend/backend interface 235A can be associated with a backend service 215 of the backend system 210. The first frontend/backend interface(s) 235A can serve as interface(s) for one client (e.g., an external client such as a first party autonomous vehicle 220A) to provide data to another client (e.g., a backend service 215). In this way, the frontend/backend interface(s) 235A can be external facing edge(s) of the first application programing interface platform 205A that are responsible for providing secure tunnel(s) for first party autonomous vehicles 220A to communicate with the backend system 215 (and vice versa) so that a particular backend service can be accessed by a particular first party autonomous vehicle 220A. The frontend/backend interface(s) 235A can, for example, provide a secure tunnel for the first party autonomous vehicles 220A to communicate with a backend operational domain service.

In some implementations, the first application programing interface platform 205A can include one or more first adapters 240A, for example, to provide compatibility between one or more first frontend/backend interfaces 235A and one or more of the API(s) associated with the first application programming interface platform 205A (e.g., first vehicle API 230A, etc.). The first adapter(s) 240A can provide upstream and/or downstream separation between particular infrastructure components, provide or assist with data curation, flow normalization and/or consolidation, etc.

The second application programming interface platform 205B (e.g., a public platform, etc.) can facilitate communication with one or more autonomous vehicles 220A, 220B of a third-party vehicle provider and/or the service entity vehicle provider. As described herein, a third-party vehicle provider can be an entity that makes one or more of its autonomous vehicles available to the service entity for the provision of vehicle services. This can include, for example, an individual, an original equipment manufacturer (OEM), a third-party vendor, or another entity that places autonomous vehicle(s) online with the service platform of the service entity such that the autonomous vehicle(s) can provide vehicle services of the service entity. These autonomous vehicles may be referred to as “third-party autonomous vehicles” and are shown in FIG. 2 as third-party autonomous vehicles 220B. Even though such autonomous vehicles may not be included in the fleet of autonomous vehicles of the service entity, the service infrastructure 200 (e.g., of the service entity's service platform, etc.) can allow the third-party autonomous vehicles 220B to provide vehicle services offered by the service entity, access one or more backend services 215 of the backend system 210, etc.

The second application programming interface platform 205B can allow the service platform to communicate directly or indirectly with autonomous vehicle(s) 220A, 220B. In some implementations, a third-party autonomous vehicle 220B and/or service entity autonomous vehicles 220A may call an API of, send data/message(s) to, receive data/message(s) from/directly through, etc. the second application programming interface platform 205B.

Additionally, or alternatively, another computing system can serve as an intermediary between the third-party autonomous vehicles 220B and the second application programming interface platform 205B (and the service platform associated therewith). For example, the service infrastructure 200 can be associated with and/or in communication with one or more third-party vehicle provider computing systems 245, such as a vehicle provider X computing system 245A and a vehicle provider Y computing system 245B. Each third-party vehicle provider X, Y can have its own, separate third-party autonomous fleet including respective third-party autonomous vehicles 220B. The third-party vehicle provider computing systems 245 can be distinct and remote from the service infrastructure 200 and provide for management of vehicles associated with that particular third-party vehicle provider. As shown in FIG. 2, a third-party vehicle provider computing system 245 can include its own backends and/or frontends for communicating with other systems (e.g., third-party autonomous vehicle(s) 220B, operations computing system, etc.).

The third-party computing system(s) 245A-B associated with a particular third-party autonomous vehicle fleet can serve as the communication intermediary for that fleet. For example, third-party autonomous vehicles 220B associated with third-party vehicle provider X can communicate with the third-party vehicle provider X computing system 245A which can then communicate with the service infrastructure 200 (e.g., to access the available backend services 215) via the second application programming interface platform 205B.

Data from the service infrastructure 200 (e.g., the backend services 215) can be communicated to the vehicle provider X computing system 245A (e.g., via the second application programming interface platform 205B) and then to the third-party autonomous vehicles 220B associated with third-party vehicle provider X. In another example, third-party autonomous vehicles 220B associated with third-party vehicle provider Y can communicate with the third-party vehicle provider Y computing system 245B which can then communicate with the service infrastructure 200 (e.g., to access the available backend services 215) via the second application programming interface platform 205B. Data from the service infrastructure 200 (e.g., the backend services 215) can be communicated to the third-party vehicle provider Y computing system 245B (e.g., via the second application programming interface platform 205B) and then to the third-party autonomous vehicles 220B associated with third-party vehicle provider Y.

The second application programming interface platform 205B can include a number of components to help facilitate the support, coordination, and management of the third-party autonomous vehicles 220B associated with the third-party vehicle providers. The second application programming interface platform 205B can provide access to one or more backend services 215 that are available to the third-party autonomous vehicles 220B. To help do so, the second application programming interface platform 205B can include a second API gateway 225B. The second API gateway 225B can function as a proxy for application programming interface (API) calls and can help to return an associated response. The second API gateway 225B can help provide other support functions for the service infrastructure 200 such as, for example, authentication functions, etc.

The second application programming interface platform 205B can include one or more APIs such as, for example, a second vehicle API 230B. The second vehicle API 230B can include a library and/or parameters for facilitating communications between the third-party autonomous vehicles 220B and the backend service(s) 215 of the backend system 210. For example, the second vehicle API 230B can be called by a third-party autonomous vehicle 220B and/or another system (e.g., a third-party vehicle provider computing system 245, etc.) to help communicate data, messages, etc. to and/or from an autonomous vehicle and/or other system. The second vehicle API 230B can provide for communicating such information in a secure, bidirectional manner. The second API 230B may be referred to herein as a provider agnostic API.

The second application programming interface platform 205B can include second frontend/backend interface(s) 235B. Each of the second frontend/backend interface(s) 235B can be associated with a backend service 215 of the backend system 210. The second frontend/backend interface(s) 235B can serve as interface(s) for one client (e.g., an external client such as a third-party autonomous vehicle 220B, a third-party vehicle provider computing system 245) to provide data to another client (e.g., a backend service 215). In this way, the second frontend/backend interface(s) 235B can be external facing edge(s) of the second application programing interface platform 205B that are responsible for providing secure tunnel(s) for third-party autonomous vehicles 220B (and/or other intermediary systems) to communicate with the backend system 210 (and vice versa) so that a particular backend service 215 can be utilized. In some implementations, the second application programing interface platform 205B can include one or more second adapters 240B, for example, to provide compatibility between one or more second frontend/backend interfaces 235B and one or more of the API(s) associated with the second application programming interface platform 205B (e.g., second vehicle API 230B, etc.).

In some implementations, the first party autonomous vehicles 220A can utilize the second application programming interface platform 205B to access/communicate with the service platform/backend service(s) 215. This can allow for greater accessibility and/or back-up communication options for the first party autonomous vehicles 220A.

In some implementations, the service infrastructure 200 can facilitate communication between the service platform and one or more other system(s)/platform(s) 250 of the service entity/operations computing system. By way of example, the service entity may have (e.g., the operations computing system may include, etc.) one or more other system(s)/platform(s) 250 for facilitating one or more vehicle and/or vehicle services. By way of example, the other system(s)/platform(s) 250 can include a system configured to indicate one or more services/vehicles that are available to a user and/or other system. As another example, the other system(s)/platform(s) 250 can include a system configured to coordinate the provision of vehicle services by human-driven vehicles and/or vehicle services that are specifically associated with certain types of services (e.g., delivery services, aerial transport services, etc.). The other system(s)/platform(s) 250 may communicate with the service platform utilizing the service infrastructure 200 to determine, for example, whether any autonomous vehicles would be available to a user for any potential vehicle services.

The backend system 210 can host, store, execute, etc. one or more backend services 215. The backend service(s) 215 can be implemented by system client(s), which can include hardware and/or software that is remote from the autonomous vehicles and that provide a particular service to an autonomous vehicle. The backend service(s) 215 can include a variety of services that help coordinate the provision of vehicle service(s) and support the autonomous vehicles and/or the third-party vehicle providers performing/providing those vehicle service(s). The backend software service(s) 215 can include a plurality of different services such as, for example, one or more trip assignment service(s), matching/deployment software service(s), routing service(s), supply positioning service(s), payment service(s), remote operator service(s), operational domain service(s), and/or any other software service that can contribute to the provisioning of a transportation service.

By way of example, the backend software services 215 accessible to the autonomous vehicles during the performance of a vehicle service can include supply positioning service(s) to route the vehicle to a location (e.g., an expected high density area, etc.) after/before a vehicle service, payment service(s) (e.g., to process payments for the vehicle service), remote assistance/operator service(s) (e.g., to control the vehicle in one or more potentially hazardous circumstances, etc.), and/or any other software service that can contribute to the performance of a vehicle service. As another example, the backend software services 215 accessible to a service provider computing system (e.g., the service entity, the vehicle providers 245A, 245B, the other system(s)/platform(s) 250, etc.) before the performance of a vehicle service can include a matching service, an itinerary service, and/or any other software service that can contribute to the scheduling/assignment of the vehicle service. The backend software services can be provided and maintained at backend system 210 (e.g., of the operations computing system 104) configured to process a plurality of requests for access (e.g., from user device, vehicles, vehicle providers, service provider computing systems, etc.) to one or more of the software services.

For instance, the backend software service(s) 215 can include a backend operational domain service configured to generate, authenticate, verify, and modify operational domains (e.g., geographies within which autonomous vehicles can navigate) for each of the autonomous vehicles 220A, 220B. The backend service(s) 215 (e.g., the backend operational domain service) can be accessible to each of the vehicles 220A, 220B, vehicle provider computing system(s) 245 associated with the vehicles 220B, and/or any other device (e.g., a user device, etc.) associated with the performance of a transportation service before, during, and/or after the performance of the transportation service to, for example, obtain and/or modify an operational domain for vehicles 220A, 220B.

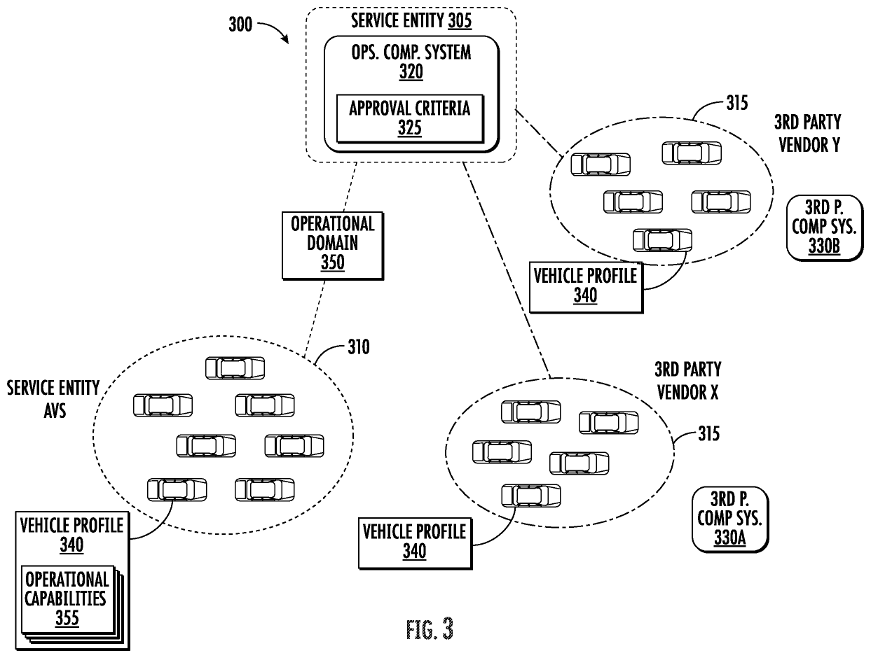

For example, FIG. 3 depicts an example vehicle ecosystem 300 according to example embodiments of the present disclosure. The ecosystem 300 can include vehicles 310, 315 associated with one or more vehicle providers including, for example, the service entity 305, a third-party vehicle provider X associated with the vehicle provider X computing system 330A, a third-party vehicle provider Y associated with the vehicle provider Y computing system 330B, an individual (e.g., owning/leasing a human driven vehicle), etc. As discussed herein, the service entity 305 can utilize a plurality of vehicles including, but not limited to, service entity/first-party vehicles 310 and/or third-party vehicles 315 (e.g., third-party vehicle provider X autonomous vehicle, third-party vehicle provider Y autonomous vehicles, etc.) to provide vehicle services. A vehicle 310, 315 can be included in one or more fleets. A fleet can include one or a plurality of vehicles. The service entity 305 can be associated with a first computing system such as, for example, an operations computing system 320 (e.g., implementing the service infrastructure, service platform, etc.). The operations computing system 320 of the service entity 305 can help coordinate, support, manage, facilitate, etc. the provision of vehicle service(s) by the vehicles 310, 315. The service entity 305, vehicles 310, 315, and operations computing system 320 can include/represent the service entities, vehicles, and operations computing systems discussed with reference to one or more other figures described herein.

The vehicles 310, 315 can include human-driven and/or autonomous vehicles of a vehicle provider. As discussed herein, the vehicle providers can include the service entity (supplying “first-party autonomous vehicles” or “service entity autonomous vehicles”) and/or one or more third-party vehicle providers (supplying “third-party autonomous vehicles”). The vehicle providers can make their fleets (or a portion of their fleets) of vehicles available (e.g., through the service entity 305, etc.) such that the vehicles are available for performing vehicle services (e.g., to address a user service request). A vehicle involved in a transportation service offered by the service entity 305 can include one of a plurality of autonomous vehicles (e.g., of the vehicle fleets 310, 315) associated with the service entity 305.

Each vehicle 310, 315 can be configured to autonomously operate in various environments based, at least in part, on one or more factors and/or directives (e.g., from the service entity 305). Each environment can be included in a travel way network (e.g., road network) associated with map data (e.g., a preconstructed and dynamically updated road map information, flight map information including one or more defined sky lanes, water map information including waterways, etc.). The map data, for example, can define one or more portions (e.g., travel way segments) of the travel way network. For example, the travel way network can include a plurality of travel way segments within (and/or or above) a geographic region (e.g., a city, county, town, neighborhood, etc.). The map data can define each of the travel way segments and include a plurality of segment attributes for each travel way segment of the plurality of travel way segments. The vehicles 310, 315 can be restricted from and/or approved to operate in certain environments (e.g., portions) of a travel way network. For example, an autonomous vehicle can be approved for operating within an environment due to legal allowances (e.g., traffic regulations allowing autonomous driving, noise regulations allowing for aerial vehicles, etc.), operational capabilities 355 of the vehicles 310, 315, and/or any other factor that can affect the safe operation of the vehicles 310, 315 within a particular environment.

By way of example, the vehicles 310, 315 can be associated with one or more operational capabilities 355. As an example, the vehicles 310, 315 can be associated with operational capability(s) 355 based, at least in part, on a fleet of autonomous vehicles corresponding to the vehicles 310, 315. For example, each of the one or more fleets of vehicles can be associated with a set of operational capabilities. In some implementations, the operational capabilities of each vehicle in a respective fleet of vehicles can correspond to the set of operational capabilities associated with the respective fleet of vehicles. The operational capabilities 355 of a vehicle and/or a fleet can indicate the capabilities (e.g., autonomy capabilities, etc.) the vehicle/fleet is able to perform, the capabilities the vehicle/fleet are unable to perform, areas in which the vehicle/fleet are able and/or permitted to operate, areas in which the vehicle/fleet are unable and/or restricted from operating, etc. For instance, the operational capabilities 355 of an autonomous vehicle can be indicative of one or more vehicle maneuvers, speeds, turning angles, and/or any other movement that the autonomous vehicle can reliably perform on a roadway. In addition, or alternatively, the operational capabilities 355 of an autonomous vehicle can be indicative of one or more geographic and/or timing permissions/restrictions due to weather conditions, lighting conditions, traffic regulations, and/or any other factor that can contribute to the reliable performance of the autonomous vehicle.

As an example, each vehicle 310, 315 associated with the service entity (e.g., service entity vehicles 310, third-party vehicles 315, etc.) can be associated with a corresponding vehicle profile 340. Each vehicle profile 340 can represent one or more operational capabilities 355 of a vehicle associated with the service entity 305. The vehicle profile 340 can be periodically updated to reflect the current operational capabilities 355 of an autonomous vehicle. For example, the vehicle profile 340 for an autonomous vehicle can be updated in response to software/hardware updates, environmental conditions (e.g., rain may affect operational capabilities of an autonomous vehicle, etc.), and/or any other event that may have an impact on the operational capabilities 355 of vehicles 310, 315.

To ensure safe operation, the vehicle 310, 315 can be configured to operate within one or more approved areas of a travel way network. An approved area of a travel way network can be identified by an operational domain 350. The operational domain 350 can include a complete set of external conditions under which an autonomous vehicle is approved for use (e.g., operation on public roads, certain sky lanes, etc.) in a self-driving mode. As an example, an operational domain 350 can be indicative of one or more operational travel way segments of a plurality of travel way segments of a travel way network. An operational domain 350 can be determined for and provided to one or more of the vehicles 310, 315 based, at least in part, on approval criteria 325 defined by the service entity 305. The approval criteria 325, for example, can be defined based, at least in part, on policies of the service entity 305.

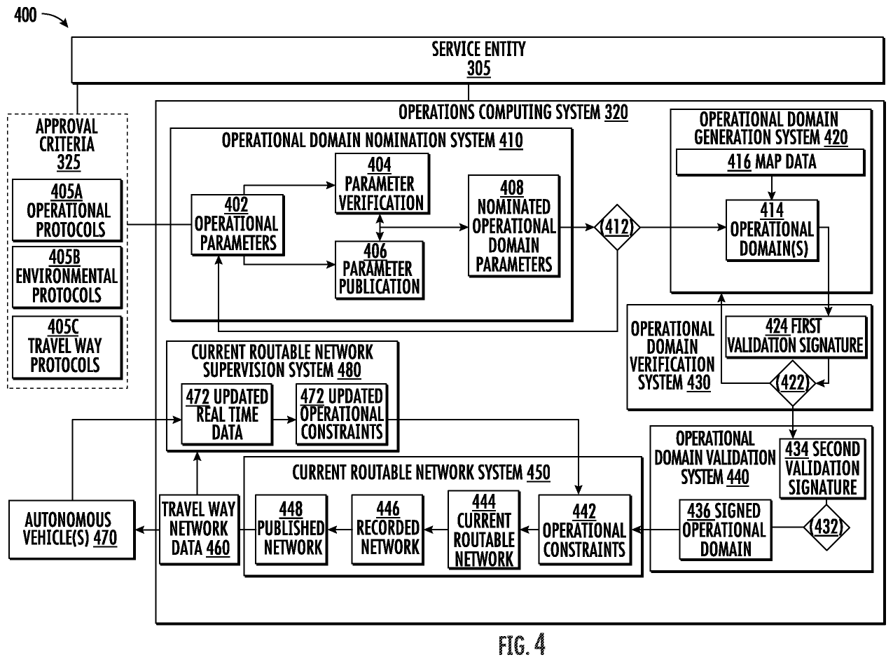

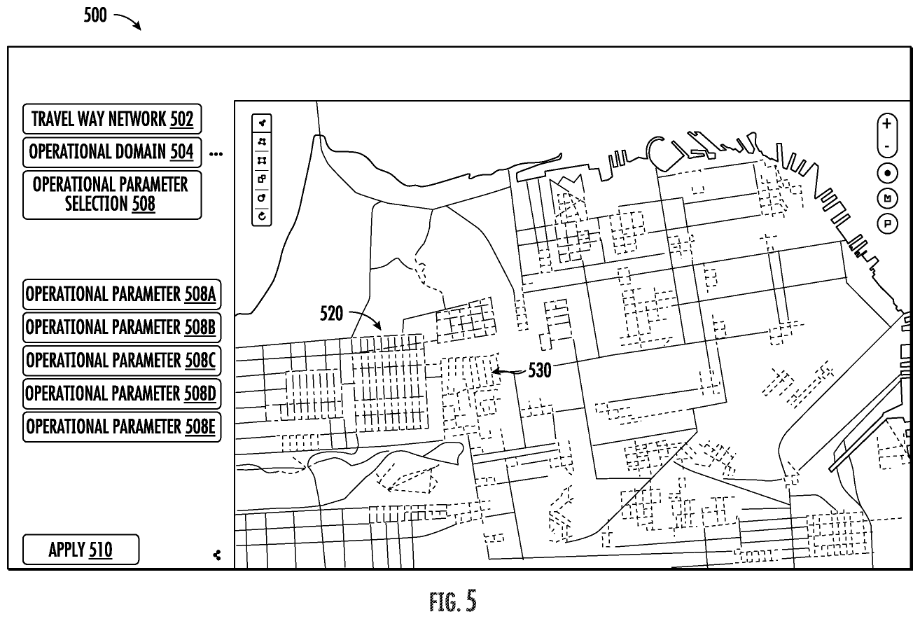

FIG. 4 depicts an example operational domain service architecture 400 according to example embodiments of the present disclosure. An operations computing system 320 (e.g., operations computing system 190A, backend operational domain service of backend system 210, etc.) of the service entity 305 can generate one or more operational domain(s) 414 for a travel way network based, at least in part, on map data 416 representative of the travel way network and operational domain parameter(s) 402. For example, the operations computing system 320 can include one or more computing devices remote from one or more autonomous vehicle(s) 470. The operations computing system 320 can include one or more communication interfaces communicatively connected to the autonomous vehicle(s) 470. In some implementations, as described in further detail herein with reference to FIGS. 5-7, the operations computing system 320 can include one or more display devices. The display device(s) can be configured to present one or more user interfaces (e.g., interfaces 500, 600, 700, etc.) configured to display map and/or autonomous vehicle information. In some implementations, a user can interact with the one or more user interfaces to provide user input data (e.g., a query, etc.) to the operations computing system 320.

An operational domain 414 can represent a set of parameters (e.g., nominated operations domain parameters 408) within which autonomous operation of the vehicle computing system (and/or automated driving features thereof) can be permissible. Beyond technical design, an operational domain 414 can consider factors such as, for example, areas of business interest, service entity policies, training, optics, and/or other permissions (e.g., regulatory, etc.). A defined and approved operational domain can be required for permissible deployment of the autonomous vehicle(s) 470 in self-driving mode on public travel ways (e.g., public roads, public sky lanes, etc.).

Per policy, a service entity 305 can have a number of quality controls that are deployed and monitored to ensure acknowledgements are implemented, adhered to, and measured. Such quality controls can be implemented by an operational domain service. For example, the operational domain service architecture 400 can include software tools (e.g., subsystems 410, 420, 430, 440, 450, 480) to help address the quality controls. The operational domain service architecture 400 illustrates a cohesive workflow for supporting verifiable and safe self-driving operational domain management. As discussed herein, the software tools (e.g., subsystems 410, 420, 430, 440, 450, 480) of the operational domain service architecture 400 enables users to safely verify, deploy, and/or enforce operational domain routing and positioning implications to/for autonomous vehicles 470.

More particularly, the operations computing system 320 can include one or more subsystems 410, 420, 430, 440, 450, 480. Each subsystem can be configured to implement one or more portion(s) of an operational domain life cycle. By way of example, the operations computing system 320 can include an operational domain nomination system 410 configured and/or utilized to generate and/or nominate a plurality of operational domain parameters 402, 408 based, at least in part, on policies of the service entity 305. In addition, or alternatively, the operations computing system 320 can include an operational domain generation system 420 configured and/or utilized to generate one or more operational domain(s) 414 based, at least in part, on the operational domain parameters 402, 408. For instance, the operational domain(s) 414 can be generated by applying the one or more nominated operational domain parameters 408 to one or more map versions (e.g., map data 416) associated with a respective travel way network.

As another example, the operations computing system 320 can include an operational domain verification system 430 configured and/or utilized to verify that the operational domain(s) 414 achieve the policies of the service entity 305. For instance, the operational domain verification system 430 can be configured and/or utilized to generate a first cryptographic validation signature 424 for an operational domain 414. As yet another example, the operations computing system 320 can include an operational domain validation system 440 configured and/or utilized to validate the operational domain(s) 414 before deployment. For example, the operational domain validation system 440 can be configured and/or utilized to generate a second cryptographic validation signature 434 for the operational domain(s) 414 based, at least in part, on the first validation signature 424. In some implementations, the operations computing system 320 can include a current routable travel way network system 450 configured and/or utilized to generate one or more current routable travel way network(s) 444 that further constrain the operational domain(s) 414. In addition, in some implementations, the operations computing system 320 can include a current routable travel way network supervision system 480 configured and/or utilized to ensure that the operational domain(s) 414 and/or current routable travel way network(s) 444 continues to achieve the policies of the service entity 305.

The operations computing system 320 (e.g., operational domain generation system 420) can obtain map data 416 associated with the travel way network including a plurality of travel way segments. The map data 416 can include a plurality of segment attributes for each travel way segment of the plurality of travel way segments. The plurality of segment attributes for a respective travel way segment describe one or more speed limits, road grades, lane widths, traffic signs, turn radiuses, vehicle maneuvers, and/or any other characteristic of a travel way. For example, the map data 416 can include a plurality of high fidelity tags, each tag describing an attribute or characteristic of a portion (e.g., segment) of a travel way. The high fidelity tags can characterize all infrastructure of a travel way network including traffic lane widths, the presence (and/or absence) of an unprotected left turn, speed limits (and/or changes thereof), road grades, noise restrictions, etc. In some implementations, the high fidelity tags can be generated (e.g., automatically based, at least in part, on one or more rules-based techniques, manually, etc.) based, at least in part, on one or more policies of the service entity (and/or third-party map distributor). In some implementations, the map data 416 can include the same map data utilized by an autonomous vehicle (e.g., one of vehicle(s) 470) for perceiving and navigating within its environment. The map data 416 can include multiple versions. Each map version can be descriptive of an updated set of segment attributes and/or road segments for a travel way network.

In addition, or alternatively, the operations computing system 320 (e.g., operational domain generation system 420) can obtain one or more operational domain parameter(s) 402 for the plurality of travel way segments. The operational domain parameter(s) 402 can be indicative of a range of acceptable values for the plurality of segment attributes for each travel way segment of the plurality of travel way segments. As an example, the range of acceptable values can include an acceptable road grade range for a road grade segment attribute between negative ten percent to positive ten percent. As another example, the range of acceptable values can include an acceptable unprotected left turn range for an unprotected left turn segment attribute of “no” (e.g., indicating that the road segment does include an unprotected left turn). In this manner, the range of acceptable values can designate any number of different values as acceptable for each of the plurality of road segment attributes.

The operational domain parameter(s) 402 can be based, at least in part, on approval criteria 325 associated with the service entity 305. For instance, the approval criteria 325 can include one or more safety, legal, and/or performance considerations associated with the service entity 305. As one example, the approval criteria 325 can be associated with one or more operational capabilities of a fleet of autonomous vehicles associated with the service entity 305. For instance, the approval criteria 325 can include one or more operational protocols 405A, one or more environment protocols 405B, and/or one or more travel way protocols 405C associated with the fleet of autonomous vehicles and/or the service entity 305. The operational protocol(s) 405A can be indicative of one or more restricted vehicle maneuvers (e.g., unprotected left turns, speed limit thresholds, etc.), the environment protocol(s) 405B can be indicative of one or more restricted operating environments of the travel way network (e.g., weather conditions, lighting conditions, etc.), and the travel way protocol(s) 405C can be indicative of one or more preferred segment attributes (e.g., a preferred road width, lane width, sky lane width, road grade, etc.).

At least one of the operational protocol(s) 405A, environment protocol(s) 405B, and/or travel way protocol(s) 405C can be based, at least in part, on the one or more operational capabilities associated with the fleet of autonomous vehicles. By way of example, an autonomous vehicle's operational capabilities can identify a reduction in performance when traversing travel way segments with road grades below negative ten percent and/or above positive ten percent. In such a case, the operational protocol(s) 405A can include a requirement to constrain an operational domain to travel way segments within a particular range of road grades. As another example, an autonomous vehicle's operational capabilities can identify an inability to safely perform an unprotected left turn. In such a case, the operational protocol(s) 405A can include a requirement restricting an unprotected left turn. As an example, the operational protocol(s) 405A can include a requirement for a travel way segment to have a null (e.g., zero, “No,” etc.) value for any unprotected left turn attribute.

The operational domain parameter(s) 402 can be determined and/or obtained by the operations computing system 320. For instance, the operations computing system 320 can obtain user input including the operational domain parameter(s) 402. For example, FIG. 5 depicts an example user query interface 500 according to example embodiments of the present disclosure. The user query interface 500 can include a map interface depicting a number of connected operational road segments 520 and/or disconnected operational road segments 530. In addition, the user query interface 500 can include a plurality of interactive widgets 502, 504, 508, 510 with which a user may interact to input user query information. For example, the interactive widgets 502, 504, 508, 510 can include road network selection widget 502, an operational domain widget 504, an operational parameter selection widget 508, and/or an application widget 510.

The operations computing system 320 can present, via one or more display devices, the user query interface 500 indicative of a plurality of potential travel way segment attributes. A user can interact with the user query interface 500 (e.g., via interactive widgets 502, 504, 508, 510) to input a domain query including the operational domain parameter(s) 508A-E. In this manner, the operations computing system 320 can obtain, from the user via the user query interface 500, a domain query including the operational domain parameter(s) 508A-E. In some implementations, the operations computing system 320 can generate an initial operational domain (e.g., including connected operational road segments 520 and/or disconnected operational road segments 530) and continuously update the initial operational domain in response to receiving interaction data indicative of new and/or changes to the operational domain parameter(s) 508A-E (e.g., as the user interacts with the user query interface 500). For instance, the user query interface 500 can be configured to generate and display connected operational road segments 520 and/or disconnected operational road segments 530 based, at least in part, on operational parameters 508A-E in response to receiving interaction data indicative of a selection of the application widget 510.

Turning back to FIG. 4, the operations computing system 320 (e.g., operational domain nomination system 410) can be configured to automatically generate and/or nominate the operational domain parameter(s) 402 based, at least in part, on one or more service entity policies. For instance, the operations computing system 320 (e.g., operational domain nomination system 410) can generate and/or nominate the operational domain parameter(s) 402 during an operational domain definition process. The operational domain definition process begins with limitations (e.g., autonomous system limitations, policy limitations, safety limitations) to the autonomous vehicle(s) 470. For example, the limitations can be defined by the approval criteria 325. The operations computing system 320 (e.g., operational domain nomination system 410) can determine (e.g., based, at least in part, on manual input, automatically based, at least in part, on one or more rules-based techniques, etc.) operational domain parameter(s) 402 in accordance with the approval criteria 325. The operational domain parameter(s) 402 can be verified (at 404) by one or more systems and/or organizations associated with the service entity and published (at 406) by the one or more systems and/or organizations for review by one or more other service entity counterparts. For example, the operational domain parameter(s) 402 can be expressed in program definitions and instantiated in controlled documents and/or databases to guide the operational domain creation process. After verification (at 404) and publication (at 406) of the operational domain parameter(s) 402, one or more of the operational domain parameter(s) 402 can be nominated for defining an operational domain. The nominated operational domain parameter(s) 408 can include the verified and published operational domain parameter(s) 402.

The operational domain parameter(s) 402 can include a range of acceptable values for one or more travel way segment attributes of a travel way network. For example, the operations computing system 320 (e.g., operational domain nomination system 410) can determine the range of acceptable values (e.g., as identified by the operational domain parameter(s) 402) based, at least in part, on at least one of the operational protocol(s) 405A, the environmental protocol(s) 405B, and/or the travel way protocol(s) 405C. In some implementations, the operational domain parameter(s) 402 can be modified (e.g., manually and/or automatically at 404, 406) based, at least in part, on one or more risk thresholds defining acceptable risks to passenger convenience relative to a desired reach of an autonomous vehicle. For instance, each value (e.g., road grade values of a road grade attribute) of the plurality of travel way segment attributes can be associated with a risk value indicating an impact of the respective value on transportation desirability (e.g., a high road grade value can be less desirable for transportation, etc.). In such a case, the operations computing system 320 can be configured to automatically modify (e.g., during verification at 404 or publication at 406) operational domain parameter(s) 402 to accommodate for risk threshold(s) identified by the service entity 305.

In some implementations, the operational domain parameter(s) 402 can be determined based, at least in part, on a performance threshold. The performance threshold, for example, can identify a desired ride quality for an autonomous vehicle. The desired ride quality can identify a desired level of passenger comfort for a passenger of the autonomous vehicle. The performance threshold can be determined based, at least in part, on the one or more service entity policies and/or rider input. For example, in some implementations, the operations computing system 320 can obtain a performance threshold associated with an autonomous vehicle. As an example, the performance threshold can be associated with a rider of a ride-sharing service offered by the service entity 305. In such a case, the performance threshold can include a desired ride quality (e.g., as measured by sliding scale such as a one to five star rating system, etc.) identified by the rider (e.g., via a mobile device, etc. associated with the rider). The operations computing system 320 can generate the operational domain parameter(s) 402 based, at least in part, on the one or more of the one or more travel way protocol(s) 405C, environmental protocol(s) 405B, or operational protocol(s) 405A associated with the fleet of autonomous vehicles and the performance threshold associated with the autonomous vehicle. As an example, operational domain parameter(s) 402 associated with a vehicle speed can be increased within limitations prescribed by the approval criteria 325 (e.g., speed limits, etc.) in accordance with a lower performance threshold and reduced in accordance with a higher performance threshold. In this manner, a rider of an autonomous vehicle can have input on the balance between speed and rider comfort.

The operations computing system 320 (e.g., operational domain generation system 420) can generate operational domain(s) 414 for the fleet of autonomous vehicles based, at least in part, on the map data 416 and the one or more operational domain parameter(s) 402. For example, the operations computing system 320 (e.g., operational domain generation system 420) can pull the one or more nominated operational domain parameter(s) 408. The nominated operational domain parameter(s) 408 can be verified (at 412) before being by the operations computing system 320 (e.g., operational domain generation system 420). An operational domain 414 can be generated in the event that the nominated operational domain parameter(s) 408 comply with the approval criteria 325. In the event that the nominated operational domain parameter(s) 408 do not comply with the approval criteria 325, the parameter(s) 402 may be modified.

Each operational domain 414 can be associated with a respective set of operational domain parameter(s) 402 (e.g., nominated operational domain parameters 408) corresponding to the operational domain 414. An operational domain 414 can be indicative of one or more operational travel way segments of the plurality of travel way segments of a travel way network. The plurality of segment attributes for each of the one or more operational travel way segments can achieve each of the one or more operational domain parameter(s) 402 (e.g., of the set of operational domain parameter(s) 408 corresponding to the operational domain 414). For example, the operations computing system 320 can compare each of the plurality of segment attributes for each of the plurality of travel way segments to a corresponding operational domain parameter (e.g., a road grade attribute compared to an operational domain parameter indicative of an acceptable range of road grades, etc.). The operations computing system 320 can filter out any non-conforming travel way segment of the travel way network from the operational domain 414. A non-conforming travel way segment, for example, can be associated with a segment attribute that does not achieve a corresponding operational domain parameter.

In some implementations, the operations computing system 320 can generate one or more operational domains 414 for a fleet of autonomous vehicles based, at least in part, on the map data 416 and the operational parameter(s) 402. As illustrated by FIG. 5, the operational travel way segments of the operational domain(s) 414 can include one or more disconnected operational travel way segments and/or one or more connected operational travel way segments. The operational domain(s), for example, can include a connected operational domain indicative of the one or more connected operational travel way segments and/or a disconnected operational domain indicative of the one or more connected operational travel way segments and the one or more disconnected operational travel way segments.

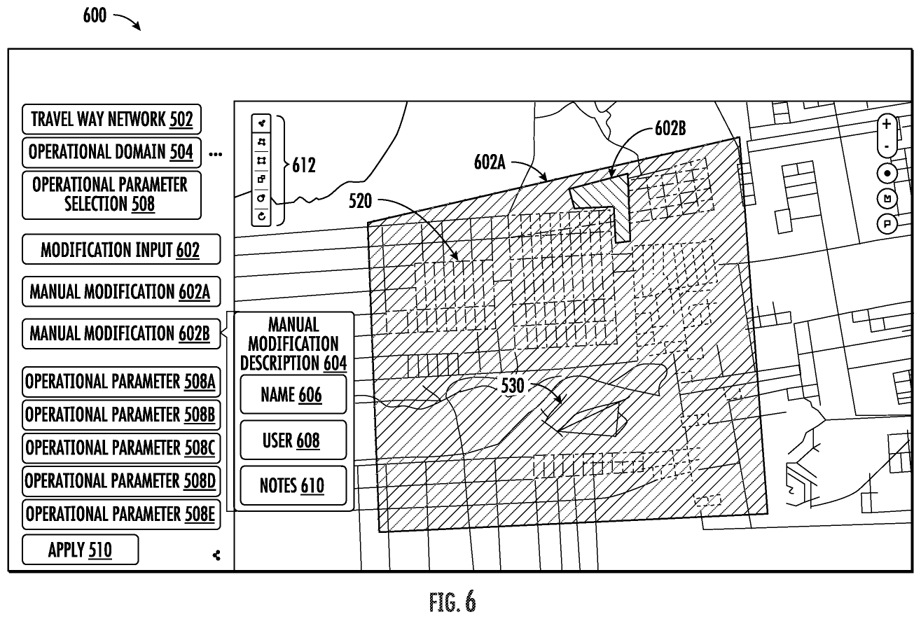

The operational domain(s) 414 can include one or more manual inclusions and/or exclusions. The manual inclusions and/or exclusions, for example, can be input by a user via a modification user interface. By way of example, FIG. 6 depicts a modification user interface 600 according to example embodiments of the present disclosure. In some implementations, the modification interface 600 can include the user query interface 500 and/or one or more functionalities described with reference to the user query interface 500. For example, the modification interface 600 can include a map interface depicting a number of connected operational road segments 520 and/or disconnected operational road segments 530. In addition, the modification interface 600 can include a plurality of interactive widgets 502, 504, 508, 510 with which a user may interact to input user query information. For example, the interactive widgets 502, 504, 508, 510 can include a road network selection widget 502, an operational domain widget 504, an operational parameter selection widget 508, and/or an application widget 510 as described with reference to FIG. 5. In addition, the modification interface 600 can include modification widget(s) 602 and/or interactive tools 612 for inputting manual modification(s) 602A-B to an operational domain. The modification widget(s) 602, for example, an include one or more interactive elements configured to accept information (e.g., coordinates, road segments, and/or other geographic information) indicative of one or more travel way segments to exclude and/or include as an operational travel way segment of an operational domain. In addition, or alternatively, the modification interface 600 can include interactive tools 612 such as one or more drawing tools, bounding box tools, etc. such that a user can easily draw and/or otherwise indicate a travel way segment to exclude and/or include as an operational travel way segment of an operational domain.

The manual modification(s) 602A-B can be created within a map displayed by the modification interface 600. The map, for example, can be generated based, at least in part, on map data indicative of a latest version of AV maps. The manual modification(s) 602A-B can include an outline 602A of the desired area within the travel way network covered by the operational domain. The proposed operational domain can enumerate all operational domain parameter(s) 508A-E. Each of the manual modification(s) 602A-B can be associated with a manual modification description 604 (e.g., including a name 606 for the modification, a user 608 corresponding the modification, and/or one or more note(s) 610 associated with the modification) describing any and all “exceptions” and/or reasons thereof for the manual modification(s) 602A-B. In some implementations, the operational domain can further specify whether each operational travel way segment of the operational domain is available for autonomous and/or manual operation or forbidden for all types of operation.

In some implementations, the operations computing system can provide for display, via the one or more display devices, the modification interface 600 indicative of the travel way network, the one or more connected operational travel way segments, and/or the one or more disconnected operational travel way segments. The modification interface 600 can include a plurality of interactive travel way segments identifying the one or more connected operational travel way segments and/or the one or more disconnected operational travel way segments. The operations computing system can obtain, via the modification interface 600, user input indicative of an interactive travel way segment of the plurality of interactive travel way segments and, in response to the user input, provide for display, via the modification interface 600, a plurality of respective segment attributes for a respective travel way segment corresponding to the interactive travel way segment.

In addition, the user input can be indicative of a manual inclusion 602A and/or exclusion 602B of a travel way segment to an operational domain. For example, a user can analyze the modification interface 600 (and/or the operational domain presented by a map interface of the modification interface 600) to determine one or more additional operational travel way segments and/or one or more nonconforming travel way segments of the operational domain. As described above, the modification interface 600 can include one or more modification widgets 602 and/or interface tools 612 (e.g., a drawing tool, selection tool, etc.) usable by the user to identify the additional operational travel way segment(s) 602A and/or nonconforming travel way segment(s) 602B. For instance, a user can select an operational travel way segment and change its status to nonoperational to identify a nonconforming operational travel way segment. In addition, the user can select a nonconforming travel way segment and change its status to operational to identify an additional operational travel way segment.

After review, the user can submit (e.g., via the application widget 510) the operational domain for approval. In some implementations, the operational domain can be named (e.g., via operational domain widget 504), a travel way network can be specified (e.g., via travel way network 502), and operational domain summary can be provided when the user submits the operational domain for approval.

Turning back to FIG. 4, the operations computing system 320 (e.g., operational domain verification system 430, operational domain validation system 440, etc.) can generate verification data (e.g., first validation signature 424, second validation signature 434, etc.) for a proposed operational domain based, at least in part, on one or more comparisons between the proposed operational domain and the approval criteria 325. For example, the proposed operational domain can be created based, at least in part, on operational domain parameter(s) 402 that are generated based, at least in part, on the approval criteria 325. The verification data can be indicative of a verification (e.g., manual, automated, etc.) that the resulting operational domain (and/or the parameters used to generate the operational domain) satisfy the approval criteria 325.

In some implementations, the proposed operational domain can be verified during a two-step procedure. During the first step (e.g., performed by the operational domain verification system 430), the proposed operational domain can be verified with respect to any manual modifications to the proposed operational domain. During the second step (e.g., performed by the operational domain validation system 440), the proposed operational domain can be verified with respect to each operational travel way segment of the proposed operational domain.

In some implementations, the first step can be manually accomplished by one or more functional service entity approver(s) based, at least in part, on the manual modification(s) to the proposed operational domain. For instance, the operations computing system 320 (e.g., operational domain verification system 430) can generate and/or provide one or more notifications (e.g., text notifications, push notifications, email notifications, etc.) to the functional approver(s) in response to the submission of a proposed operational domain. Each functional approver can be responsible for receiving every change to operational domain(s) 414 (e.g., including updates resulting from new map versions). In some implementations, the functional approver(s) can be responsible for reviewing and/or responding to a submission within a time limit (e.g., twenty-four hours, etc.).

The operations computing system 320 (e.g., operational domain verification system 430) can be configured to display (e.g., via a verification interface) the proposed operational domain (e.g., name and/or summary thereof), changes from the proposed operational domain and an old version (if applicable) of the proposed operational domain, travel way segment attributes for each of the travel way segments of the travel way network, and/or manual modification descriptions for the each of the manual modification(s). The verification interface can include one or more interactive approval and/or rejection widgets (e.g., with functionality to add context for a rejection decision). Each functional service entity approver can interact with the interactive approval and/or rejection widgets to approve and/or reject a proposed operational domain. The operations computing system 320 (e.g., operational domain verification system 430) can generate a first validation signature 424 for the proposed operational domain in response to receiving user input indicative of the interactive approval widget.

At (422), the operations computing system 320 (e.g., operational domain verification system 430) can determine whether the functional service entity approver(s) have approved the proposed operational domain. For example, the verification interface can have a visualization of the current state of approvals (e.g., functional approver(s) that have/have not approved a proposed operational domain and/or time stamps for when an approval request was sent and/or approved). At (422), the operations computing system 320 (e.g., operational domain verification system 430) can continue the second approval step in the event that each of the functional approver(s) have approved the proposed operational domain and/or further modify the proposed operational domain (e.g., via the operational domain generation system 420) in the event that at least one functional approver rejected the proposed operational domain. For example, a rejected operational domain can include a reason for the rejection. The operations computing system 320 (e.g., operational domain generation system 420) can modify a proposed operational domain based, at least in part, on the reason for the rejection.

In some implementations, the second step can be manually accomplished by the functional service entity approver(s) based, at least in part, on each of the operational travel way segments of the proposed operational domain. For instance, the operations computing system 320 (e.g., operational domain validation system 440) can generate and/or provide one or more notifications (e.g., text notifications, push notifications, email notifications, etc.) to the functional approver(s) in response to the verification of the modification(s) to a proposed operational domain. The functional approver(s) can be the same and/or one or more different functional approver(s) than those assigned to verify (e.g., via the first validation signature 424) the proposed operational domain. Each functional service entity approver can interact with the interactive approval and/or rejection widgets of a validation interface to approve and/or reject a proposed operational domain. The operations computing system 320 (e.g., operational domain validation system 440) can generate a second validation signature 434 for the proposed operational domain in response to receiving user input indicative of the interactive approval widget. In some implementations, the second validation signature 434 can be the same as the first validation signature 424.

At (432), the operations computing system 320 (e.g., operational domain validation system 440) can determine whether the functional service entity approver(s) have approved the proposed operational domain. For example, the validation interface can have a visualization of the current state of approvals (e.g., functional approver(s) that have/have not approved an operational domain and/or time stamps for when an approval request was sent and/or approved). At (432), the operations computing system 320 (e.g., operational domain validation system 440) can generate a signed operational domain 436 in the event that each of the functional approver(s) have approved the proposed operational domain and/or revoke the proposed operational domain in the event that at least one functional approver rejected the proposed operational domain.

In addition, or alternatively, the first step and/or second step can be automatically performed. For instance, the operations computing system 320 (e.g., operational domain verification system 430, operational validation system 440) can obtain domain characteristics corresponding to the operational domain 414. The domain characteristics can identify the operational domain parameter(s) 402, one or more manual travel way segment modifications to the operational domain 414, and/or the plurality of segment attributes for each of the one or more operational travel way segments. The operations computing system 320 can generate verification data (e.g., the first validation signature 424, the second validation signature 434, etc.) for the operational domain 414 based, at least in part, on the domain characteristics and the operational protocol(s) 405A, the environment protocol(s) 405B, and/or the travel way protocol(s) 405C.

In some implementations, the verification data can be generated based, at least in part, on a domain risk. For example, the operations computing system 320 can determine a domain risk for the proposed operational domain based, at least in part, on the plurality of segment attributes associated with each operational travel way segment of the proposed operational domain and/or the one or more operational domain parameter(s) 402 used to generate the proposed operational domain. The operations computing system 320 can automatically and/or manually verify the proposed operational domain based, at least in part, on a comparison between the domain risk and the one or more risk threshold(s) associated with the service entity 305. For example, in some implementations, the operations computing system 320 can automatically verify the operational domain in the event that the domain risk is lower than a risk threshold associated with the service entity 305. In addition, or alternatively, the operations computing system 320 can provide the operational domain to a user (e.g., as described above) for manual verification in the event that the domain risk is higher than a risk threshold associated with the service entity 305.

The operations computing system 320 can determine that at least one travel way segment of the one or more operational travel way segments of the proposed operational domain fails to achieve the approval criteria 325. In such a case, the operations computing system 320 can generate verification data indicative of a failed operational domain, the at least one travel way segment, and/or the approval criteria 325. For example, the verification data can identify the approval criteria 325 that is violated by the at least on travel way segment.

In addition, or alternatively, the operations computing system 320 can generate the verification data in response to determining that each of the one or more operational travel way segments of the operational domain achieve the approval criteria 325. The verification data can include one or more cryptographic validation signature(s) (e.g., the first validation signature 424, second validation signature 434, etc.) indicative of a validated operational domain. The cryptographic validation signature(s) 424, 434 can include one or more cryptographic signature(s) implemented by one or more cryptographic signing techniques such as, for example, asymmetric and/or symmetric signing processes. By way of example, the verification data can include an operational domain 436 signed in accordance with the one or more cryptographic signing techniques. The signed operational domain 434 can be indicative of a user's approval of the operational domain and/or the operations computing system's 320 approval of the operational domain for use by autonomous vehicle(s) 470.

The operations computing system 320 can provide travel way network data 460 indicative of at least one of the operational domain(s) 414 to an autonomous vehicle of the fleet of autonomous vehicles 470. For instance, the operations computing system 320 can determine an operation type associated with the autonomous vehicle. The operation type, for example, can identify whether the autonomous vehicle is associated with a vehicle operator (e.g., whether the vehicle is operated, supervised, etc. by a vehicle operator). The operations computing system 320 can determine the travel way network data 460 for the autonomous vehicle based, at least in part, on the one or more operational domain(s) 414 and the operation type. For example, the operations computing system 320 can provide travel way network data 460 indicative of the connected operational domain to the autonomous vehicle in the event that the operation type is not indicative of a vehicle operator. In addition, or alternatively, the operations computing system 320 can provide travel way network data 460 indicative of the disconnected operational domain to the autonomous vehicle in the event that the operation type is indicative of a supervisory vehicle operator.

In addition, or alternatively, the operations computing system 320 can provide the operational domain(s) 414 to the autonomous vehicle(s) 470 based, at least in part, on the verification data. For instance, the operations computing system 320 can provide the operational domain(s) 414 to the autonomous vehicle(s) 470 in response to determining that each of the one or more operational travel way segments of the operational domain(s) 414 achieve the approval criteria 325. In some implementations, the operations computing system 320 can provide, to the autonomous vehicle(s) 470, data indicative of the operational domain signed by the cryptographic validation signature(s) (e.g., signature(s) 424, 434). In such a case, the autonomous vehicle can be configured to verify the cryptographic validation signature(s) before traversing the travel way network based, at least in part, on the operational domain(s) 414. In this manner, autonomous vehicle(s) 470 can ensure vehicle safety by validating that a signed operational domain 436 has been correctly authorized for use by the operations computing system 320 and/or user thereof.

The travel way network data 460 can be indicative of operational domain(s) 414 and/or a current routable travel way network 444 (e.g., a subset of the operational domain updated based, at least in part, on real-time data). For example, in some implementations, the operations computing system 320 (e.g., current routable travel way network system 450) can generate a current routable travel way network 444 based, at least in part, on the proposed operational domain and real-time travel way data. For instance, the current routable travel way network 444 can be generated in response to determining that each of the one or more operational travel way segments of the operational domain achieve the approval criteria 325. In this manner, a current routable travel way network 444 can be only generated for verified operational domain(s). In addition, or alternatively, the operations computing system 320 can obtain selection data indicative of a selected operational domain of the one or more operational domains. In such a case, the current routable travel way network 444 can be generated for a selected operational domain. The current routable travel way network 444 can be indicative of a subset of the one or more operational travel way segments (e.g., of the verified and/or selected operational domain).

More particularly, the operations computing system 320 can obtain real-time travel way data associated with the operational travel way segment(s) of the operational domain(s) 436 (e.g., selected, verified, etc.). The real-time travel way data can be indicative of temporary travel way (e.g., roads, skylanes, waterways, etc.) conditions associated with the one or more operational travel way segments. As an example, the temporary travel way conditions can be indicative of one or more travel way defects (e.g., potholes, etc.), travel way maintenance events (e.g., construction, etc.), or travel way closures (e.g., due to events such as parades, weather (e.g., air conditions, etc.), etc.). The operations computing system 320 can generate the current routable travel way network 444 for the autonomous vehicle(s) 470 based, at least in part, on the operational domain 436 (e.g., selected, verified, etc.) and the real-time travel way data.

As an example, the operations computing system 320 can determine one or more operational constraint(s) 442 for the operational domain 436 based, at least in part, on the temporary travel way conditions. The current routable travel way network 444 can be generated based, at least in part, on the operational domain 436 and the operational constraint(s) 442. For instance, the operational constraint(s) 442 can be indicative of one or more restricted travel way segments of the one or more operational travel way segments due to the temporary travel way conditions. In such a case, the current routable travel way network 444 can be indicative of a subset of the one or more operational travel way segments.

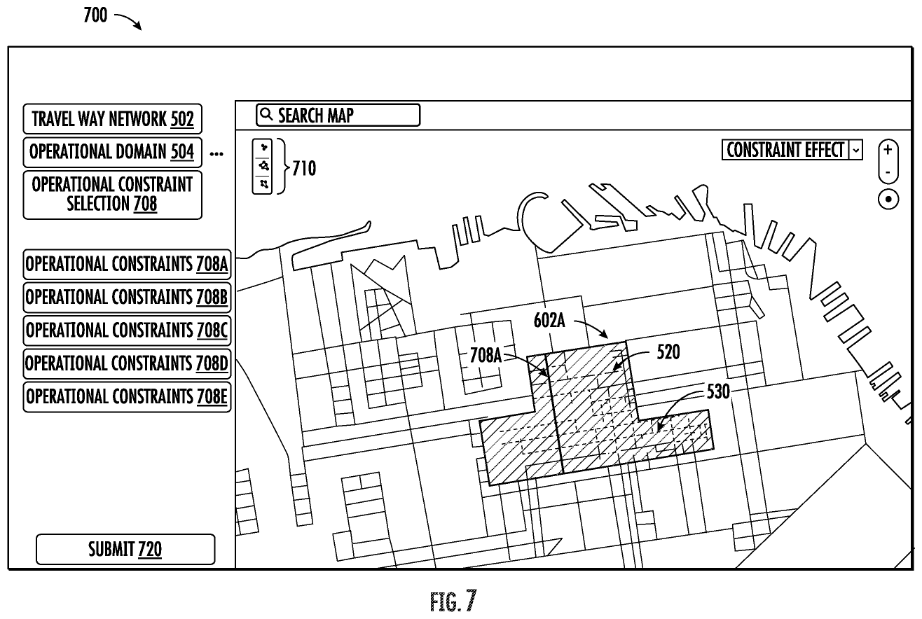

The operational constraint(s) 442 can be manually applied (e.g., via one or more selector tools of a map interface) and/or automatically determined based, at least in part, on the real-time travel way data. For example, FIG. 7 depicts an example current routable travel way network interface 700 according to example embodiments of the present disclosure. The current routable travel way network interface 700 can include the user query interface 500, modification interface 600, and/or one or more functionalities described with reference to the user query interface 500 and/or modification interface 600. For example, the current routable travel way network interface 700 can include a map interface depicting a number of connected operational road segments 520 and/or disconnected operational road segments 530. In addition, the current routable travel way network interface 700 can include a plurality of interactive widgets 502, 504, 708, 720 with which a user may interact to input information. For example, the interactive widgets 502, 504, 508, 510 can include a road network selection widget 502 and/or an operational domain widget 504 (e.g., as discussed with reference to FIG. 5). In addition, or alternatively, the interactive widgets can include an operational constraint selection widget 708 and/or interactive tools 710 (e.g., a selection tool, a drawing tool, etc.) for inputting data indicative of the one or more operational constraint(s) 708A-E to an operational domain. The operational constraint selection widget 608, for example, an include one or more interactive elements configured to accept information (e.g., coordinates, road segments, and/or other geographic information) indicative of one or more travel way segments to exclude and/or include as an operational travel way segment of an operational domain based, at least in part, on real-time travel way data. In addition, or alternatively, the current routable travel way network interface 700 can include interactive tools 712 such as one or more drawing tools, bounding box tools, etc. such that a user can easily draw and/or otherwise indicate a travel way segment to exclude and/or include as an operational travel way segment of an operational domain based, at least in part, on real-time travel way data. The current routable travel way network interface 700 can include a submission widget 720, the selection of which can cause the operations computing system to verify (and/or deploy the current routable travel way network.

Turning back to FIG. 4, the signed operational domain 442 can be pushed downstream to the current routable network system 450 where operational constraint(s) 442 can be determined by service entity personnel (e.g., via the current routable travel way network interface 700) and/or automatically (e.g., based, at least in part, on sensor data, etc.) based, at least in part, on real-time travel way data. As an example, the operational constraint(s) 442 can be determined based, at least in part, on sensor data (and/or other traffic related data) indicative of travel way closures. As an example, an operational constraint indicative of a restrictive travel way segment can be determined in response to image data representing construction (e.g., a pattern of orange construction cones, etc.) proximate to the restricted travel way segment.

In some implementations, the current routable travel way network 444 can be generated by a proxy vehicle computing system remote from the autonomous vehicle(s) 470 based, at least in part, on the real-time travel way data, the signed operational domain 436, and/or the map data 416. For example, the proxy vehicle computing system can include a remote service (e.g., running on the operations computing system 320) configured to represent the operations of a vehicle computing system onboard an autonomous vehicle. The proxy vehicle computing system can be configured to simulate the operations of an autonomous vehicle based, at least in part, on simulated data indicative of an operating environment. The proxy vehicle computing system can receive the real-time travel way data, the signed operational domain 436, and/or the map data 416 as inputs and, in response, generate a proxy vehicle cryptographic signature for the current routable travel way network. The current routable travel way network 444 can be signed by the proxy vehicle cryptographic signature (e.g., via one or more cryptographic signing techniques) to validate the current routable travel way network before deployment.

In addition, the current routable travel way network 444 can be visually verified based, at least in part, on the approval criteria, operational parameter(s) 402, and/or operation constraint(s) 442 by one or more service entity approver(s) before deployment. The current routable network system 450 can record the current routable travel way network 444. A service entity approver can review and the recorded current routable travel way network 446 and a reviewed recorded current routable travel way network 446 can be published for use by the vehicle(s) 470. For example, the published current routable travel way network 448 can be deployed to the vehicle(s) 470 for use when traversing a travel way network.

The operations computing system 320 can provide travel way network data 460 indicative of the current routable travel way network 448 (and/or an updated current routable travel way network) to the autonomous vehicle(s) 470 for use in traversing the travel way network. For example, the operations computing system 320 can provide, to the autonomous vehicle(s) 470, data indicative of the current routable travel way network 448 signed by the cryptographic validation signature and/or the proxy vehicle cryptographic signature. For example, the operations computing system 320 can select an autonomous vehicle from the fleet(s) of autonomous vehicles, determine map data 416 associated with the selected vehicle (e.g., a map version used by the autonomous vehicle), select an operational domain (e.g., of the operation domain(s) 414) based, at least in part, on the map data 416 (e.g., an operational domain generated using the determined map version), select an operational constraint set for the operational domain, generate the current routable travel way network for the vehicle based, at least in part, on the operational domain and the operational constraint set, and provide the current routable travel way network to the vehicle for use in traversing the travel way network.

In some implementations, the operations computing system 320 (e.g., current routable network supervision system 480) can be configured to continuously update an operational domain by generating an updated current routable travel way network based, at least in part, on updated real-time travel way data 472. For example, the operations computing system 320 can obtain updated real-time travel way data 472 associated with the one or more operational travel way segments of the operational domain (e.g., selected, verified, etc.). The updated real-time travel way data 472 can be obtained at a time subsequent to the real-time travel way data. In some implementations, the updated real-time travel way data 472 can be obtained from the autonomous vehicle(s) 470. For example, the autonomous vehicle(s) 470 can obtain sensor data (e.g., image data, etc.) indicative of the real-time travel way data as the autonomous vehicle(s) 470 traverse the travel way network. The sensor data, for example, can include three dimensional data points (e.g., LiDAR data, image data, etc.) descriptive of one or more traffic cones (e.g., indicative of a construction events, etc.), barriers (e.g., indicative of travel way closures, etc.), crowds (e.g., indicative of parades, etc.), and/or any other information associated with the surrounding environment that identifies a travel way condition (e.g., travel way closure, etc.). The operations computing system 320 (e.g., current routable network supervision system 480) can obtain data indicative of the sensor data (e.g., the sensor data and/or one or more determinations made based, at least in part, on the sensor data) and update one or more statuses of the plurality of travel way segments within the travel way network based, at least in part, on the data.

The operations computing system 320 (e.g., current routable network supervision system 480) can generate an updated current routable travel way network for the autonomous vehicle based, at least in part, on the selected and/or verified operational domain 436 and the updated real-time travel way data 472. For example, the operations computing system 320 (e.g., current routable network supervision system 480) can generate one or more updated operational constraint(s) 474 based, at least in part, on the updated real-time travel way data 472. The operations computing system 320 (e.g., current routable network supervision system 480) can generate the updated current routable travel way network for the autonomous vehicle based, at least in part, on the selected and/or verified operational domain 436 and the updated operational constraint(s) 474.

In some implementations, the operations computing system 320 can be configured to present, via one or more display devices, a deployment user interface. The deployment user interface can include one or more selector widgets for assigning an operational domain and/or current routable travel way network to an autonomous vehicle. For example, the selector widgets can include an autonomous vehicle selector widget for use in selecting an autonomous vehicle. In addition, the selector widgets can include a map selector widget for use in selecting a map version. The map selector widget, in some implementations, can be configured to automatically down select based, at least in part, on a map version associated with the autonomous vehicle.

In addition, the selector widgets can include an operational domain selector widget for use in selecting an operational domain. The operational domain selector widget, in some implementations, can be configured to automatically down select based, at least in part, on the operational domains associated with the selected map version. In some implementations, the selector widgets can include an operational constraint set selector widget for use in selecting an operational constraint set to be applied to the operational domain. The operational constraint set selector widget, in some implementations, can be configured to automatically down select based, at least in part, on the operational constraint sets associated with the selected map version. In this manner, the selector widgets can ensure compatibility between the autonomous vehicle(s) 470 and each component of a current routable travel way network 444.

In some implementations, the operations computing system 320 can be configured to track the autonomous vehicle(s) 470. For instance, the operations computing system 320 can obtain vehicle data indicative of a location of the autonomous vehicle(s) 470. In some implementations, the operations computing system 320 can provide for display, via one or more display devices, a map interface indicative of the travel way network, the current routable travel way network 444 for the autonomous vehicle(s) 470, and/or the location of the autonomous vehicle. For example, this can be done for every vehicle in the one or more fleets of vehicles associated with the service entity 305. The map interface can include interactive vehicles. For instance, in response to the selection of an interactive vehicle, the map interface can be configured to represent the vehicle's location, an active operational domain of the vehicle, an active current routable travel way network of the vehicle, etc.

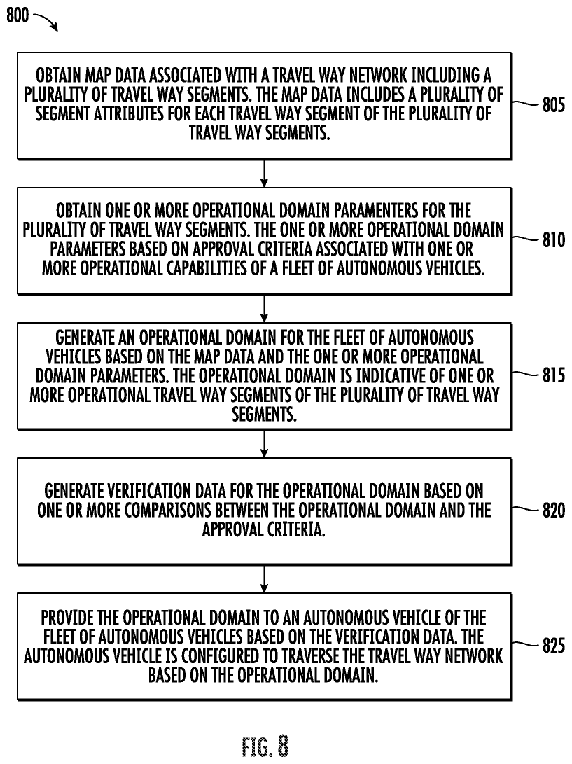

FIG. 8 depicts a flow diagram of an example method 800 for generating travel way network data according to example embodiments of the present disclosure. One or more portion(s) of the method 800 can be implemented by a computing system that includes one or more computing devices such as, for example, the computing systems described with reference to the other figures (e.g., operations computing system 190A, the backend system 210, operations computing system 320, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1-7, 9-10, etc.), for example, to generate travel way network data. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

At 805, the method 800 can include obtaining map data associated with a travel way network including a plurality of travel way segments. For example, a computing system (e.g., operations computing system 102, backend system 210, operations computing system 320, etc.) can obtain the map data associated with the travel way network including the plurality of travel way segments. The map data can include a plurality of segment attributes for each travel way segment of the plurality of travel way segments.

At 810, the method 800 can include obtaining one or more operational domain parameters for the plurality of travel way segments. For example, the computing system (e.g., operations computing system 102, backend system 210, operations computing system 320, etc.) can obtain the one or more operational domain parameters for the plurality of travel way segments. The one or more operational domain parameters can be based, at least in part, on approval criteria associated with the one or more operational capabilities of a fleet of autonomous vehicles.

At 815, the method 800 can include generating an operational domain for the fleet of autonomous vehicles based, at least in part, on the map data and the one or more operational domain parameters. For example, the computing system (e.g., operations computing system 102, backend system 210, operations computing system 320, etc.) can generate the operational domain for the fleet of autonomous vehicles based, at least in part, on the map data and the one or more operational domain parameters. The operational domain can be indicative of one or more operational travel way segments of the plurality of travel way segments.

At 820, the method 800 can include generating verification data for the operational domain based, at least in part, on one or more comparisons between the operational domain and the approval criteria. For example, the computing system (e.g., operations computing system 102, backend system 210, operations computing system 320, etc.) can generate verification data for the operational domain based, at least in part, on the one or more comparisons between the operational domain and the approval criteria.

At 830, the method 800 can include providing the operational domain to an autonomous vehicle of the fleet of autonomous vehicles based, at least in part, on the verification data. For example, the computing system (e.g., operations computing system 102, backend system 210, operations computing system 320, etc.) provide the operational domain to the autonomous vehicle of the fleet of autonomous vehicles based, at least in part, on the verification data. The autonomous vehicle can be configured to traverse the travel way network based, at least in part, on the operational domain.

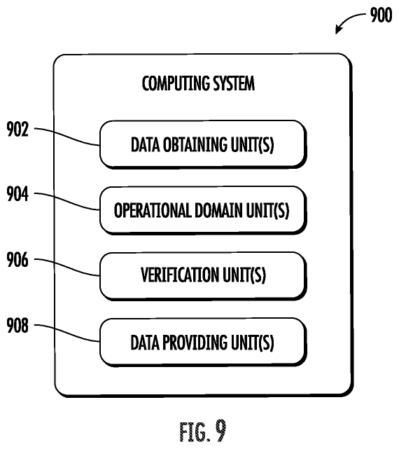

Various means can be configured to perform the methods and processes described herein. For example, FIG. 9 depicts example units associated with a computing system for performing operations and functions according to example embodiments of the present disclosure. FIG. 9 depicts a computing system 900 that can include, but is not limited to, data obtaining unit(s) 902; operational domain unit(s) 904; verification unit(s) 906; and/or data obtaining unit(s) 908. In some implementations one or more units may be implemented separately. In some implementations, one or more units may be included in one or more other units.

The means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein (including the claims). For instance, the means (e.g., data obtaining unit(s) 902, etc.) can be configured to obtain map data associated with a travel way network including a plurality of travel way segments. The map data can include a plurality of segment attributes for each travel way segment of the plurality of travel way segments. In addition, or alternatively, the means (e.g., data obtaining unit(s) 902, etc.) can be configured to obtain one or more operational domain parameters for the plurality of travel way segments. The one or more operational domain parameters can be based, at least in part, on approval criteria associated with one or more operational capabilities of a fleet of autonomous vehicles.

The means (e.g., operational domain unit(s) 904, etc.) can be configured to generate an operational domain for the fleet of autonomous vehicles based, at least in part, on the map data and the one or more operational domain parameters. The operational domain can be indicative of one or more operational travel way segments of the plurality of travel way segments. The means (e.g., verification unit(s) 906, etc.) can be configured to generate verification data for the operational domain based, at least in part, on one or more comparisons between the operational domain and the approval criteria. And, the means (e.g., data providing unit(s) 908, etc.) can be configured to provide the operational domain to an autonomous vehicle of the fleet of autonomous vehicles based, at least in part, on the verification data. The autonomous vehicle can be configured to traverse the travel way network based, at least in part, on the operational domain.

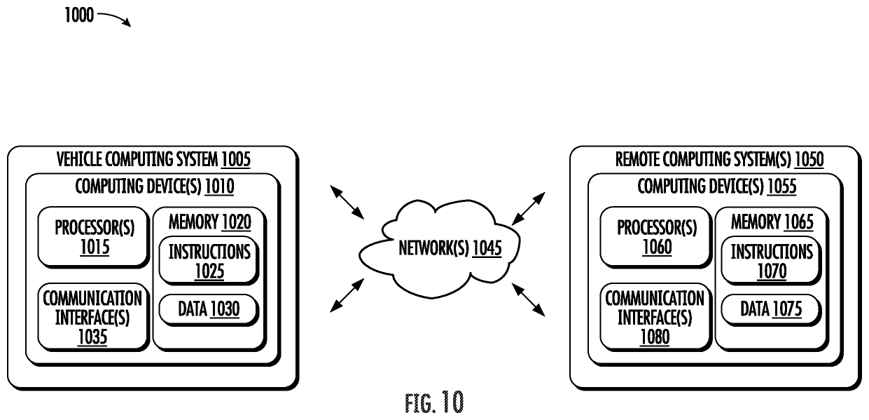

FIG. 10 depicts example system components of an example system 1000 according to example embodiments of the present disclosure. The example system 1000 can include the computing system 1005 (e.g., vehicle computing system 112, one or more vehicle devices, etc.) and the computing system 1050 (e.g., operations computing system 104, remote computing devices 106, backend system 210, vehicle state service 405, etc.), etc. that are communicatively coupled over one or more network(s) 1045.

The computing system 1005 can include one or more computing device(s) 1010. The computing device(s) 1010 of the computing system 1005 can include processor(s) 1015 and a memory 1020. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 can store information that can be accessed by the one or more processors 1015. For instance, the memory 1020 (e.g., one or more non-transitory computer-readable storage mediums, memory devices) can include computer-readable instructions 1025 that can be executed by the one or more processors 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processors 1015 cause the one or more processors 1015 to perform operations such as any of the operations and functions of or for which the computing systems described herein are configured.

The memory 1020 can store data 1030 that can be obtained, received, accessed, written, manipulated, created, and/or stored. The data 1030 can include, for instance, map data, travel network data, verification data, etc. as described herein. In some implementations, the computing device(s) 1010 can obtain from and/or store data in one or more memory device(s) that are remote from the computing system 1005 such as one or more memory devices of the computing system 1050.

The computing device(s) 1010 can also include a communication interface 1035 used to communicate with one or more other system(s) (e.g., computing system 1050). The communication interface 1035 can include any circuits, components, software, etc. for communicating via one or more networks (e.g., 1045). In some implementations, the communication interface 1035 can include for example, one or more of a communications controller, receiver, transceiver, transmitter, port, conductors, software and/or hardware for communicating data/information.

The computing system 1050 can include one or more computing devices 1055. The one or more computing devices 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more non-transitory computer-readable storage media, such as RAM, ROM, EEPROM, EPROM, one or more memory devices, flash memory devices, etc., and combinations thereof.

The memory 1065 can store information that can be accessed by the one or more processors 1060. For instance, the memory 1065 (e.g., one or more non-transitory computer-readable storage mediums, memory devices) can store data 1075 that can be obtained, received, accessed, written, manipulated, created, and/or stored. The data 1075 can include, for instance, map data, travel network data, verification data, and/or other data or information described herein. In some implementations, the computing system 1050 can obtain data from one or more memory device(s) that are remote from the computing system 1050.

The memory 1065 can also store computer-readable instructions 1070 that can be executed by the one or more processors 1060. The instructions 1070 can be software written in any suitable programming language or can be implemented in hardware. Additionally, or alternatively, the instructions 1070 can be executed in logically and/or virtually separate threads on processor(s) 1060. For example, the memory 1065 can store instructions 1070 that when executed by the one or more processors 1060 cause the one or more processors 1060 to perform any of the operations and/or functions described herein, including, for example, any of the operations and functions of the devices described herein, and/or other operations and functions.

The computing device(s) 1055 can also include a communication interface 1080 used to communicate with one or more other system(s). The communication interface 1080 can include any circuits, components, software, etc. for communicating via one or more networks (e.g., 1045). In some implementations, the communication interface 1080 can include for example, one or more of a communications controller, receiver, transceiver, transmitter, port, conductors, software and/or hardware for communicating data/information.

The network(s) 1045 can be any type of network or combination of networks that allows for communication between devices. In some embodiments, the network(s) 1045 can include one or more of a local area network, wide area network, the Internet, secure network, cellular network, mesh network, peer-to-peer communication link and/or some combination thereof and can include any number of wired or wireless links. Communication over the network(s) 1045 can be accomplished, for instance, via a network interface using any type of protocol, protection scheme, encoding, format, packaging, etc.

FIG. 10 illustrates one example system 1000 that can be used to implement the present disclosure. Other computing systems can be used as well. Computing tasks discussed herein as being performed at an operations computing system can instead be performed remote from the operations computing system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system, the computing system comprising:
one or more processors; and
one or more tangible, non-transitory, computer readable media that collectively store instructions that when executed by the one or more processors cause the computing system to perform operations, the operations comprising:
obtaining map data associated with a travel way network comprising a plurality of travel way segments, wherein the map data comprises a plurality of segment attributes for each travel way segment of the plurality of travel way segments;
obtaining one or more operational domain parameters for the plurality of travel way segments, wherein the one or more operational domain parameters are based, at least in part, on approval criteria associated with one or more operational capabilities of a fleet of autonomous vehicles;
generating an operational domain for the fleet of autonomous vehicles based, at least in part, on the map data and the one or more operational domain parameters, wherein the operational domain is indicative of one or more operational travel way segments of the plurality of travel way segments;
generating verification data for the operational domain based, at least in part, on one or more comparisons between the operational domain and the approval criteria; and
providing the operational domain to an autonomous vehicle of the fleet of autonomous vehicles based, at least in part, on the verification data, wherein the autonomous vehicle is configured to traverse the travel way network based, at least in part, on the operational domain.

2. The computing system of claim 1, wherein the approval criteria comprises one or more operational protocols, one or more environment protocols, or one or more travel way protocols associated with the fleet of autonomous vehicles, wherein at least one of the one or more operational protocols, the one or more environment protocols, or the one or more travel way protocols are based, at least in part, on the one or more operational capabilities associated with the fleet of autonomous vehicles, wherein the one or more operational domain parameters are indicative of a range of acceptable values for the plurality of segment attributes for each travel way segment of the plurality of travel way segments, and wherein the plurality of segment attributes for each of the one or more operational travel way segments achieve each of the one or more operational domain parameters.

3. The computing system of claim 2, wherein the range of acceptable values are determined based, at least in part, on at least one of the one or more operational protocols, the one or more environment protocols, or the one or more travel way protocols.

4. The computing system of claim 2, wherein the one or more operational protocols are indicative of one or more restricted vehicle maneuvers, the one or more environment protocols are indicative of one or more restricted operating environments of the travel way network, and the one or more travel way protocols are indicative of one or more preferred segment attributes.

5. The computing system of claim 2, wherein generating the verification data comprises:
obtaining domain characteristics corresponding to the operational domain, the domain characteristics indicative of the operational domain parameters, one or more manual travel way segment inclusions to the operational domain, and the plurality of segment attributes for each of the one or more operational travel way segments; and
generating the verification data for the operational domain based, at least in part, on the domain characteristics and the one or more operational protocols, the one or more environment protocols, or the one or more travel way protocols.

6. The computing system of claim 1, wherein generating the verification data further comprises:
determining that at least one travel way segment of the one or more operational travel way segments of the operational domain fail to achieve the approval criteria; and
generating verification data indicative of a failed operational domain, the at least one travel way segment, and the approval criteria.

7. The computing system of claim 1, wherein generating the verification data further comprises:
generating the verification data in response to determining that each of the one or more operational travel way segments of the operational domain achieve the approval criteria, wherein the verification data comprises a cryptographic validation signature indicative of a validated operational domain.

8. The computing system of claim 7, wherein providing the operational domain to the autonomous vehicle comprises:
providing, to the autonomous vehicle, data indicative of the operational domain signed by the cryptographic validation signature.

9. The computing system of claim 8, wherein the operations further comprise:
obtaining real-time travel way data associated with the one or more operational travel way segments of the operational domain;
generating a current routable travel way network for the fleet of autonomous vehicles based, at least in part, on the operational domain and the real-time travel way data, the current routable travel way network indicative of a subset of the one or more operational travel way segments; and
providing the current routable travel way network to the autonomous vehicle.

10. The computing system of claim 9, wherein the current routable travel way network is generated in response to determining that each of the one or more operational travel way segments of the operational domain achieve the approval criteria.

11. The computing system of claim 9, wherein the current routable travel way network is generated by a proxy vehicle computing system remote from the fleet of autonomous vehicles based, at least in part, on the real-time travel way data, the operational domain, and the map data, and wherein the operations further comprise:
generating a proxy vehicle cryptographic signature for the current routable travel way network; and
providing, to the autonomous vehicle, data indicative of the current routable travel way network signed by the cryptographic validation signature and the proxy vehicle cryptographic signature.

12. The computing system of claim 11, wherein the autonomous vehicle is configured to verify the cryptographic validation signature and the proxy vehicle cryptographic signature before traversing the travel way network based, at least in part, on the current routable travel way network.

13. A computer-implemented method, the method comprising:
obtaining, by a computing system comprising one or more computing devices, map data associated with a travel way network comprising a plurality of travel way segments, wherein the map data comprises a plurality of segment attributes for each travel way segment of the plurality of travel way segments;
obtaining, by the computing system, one or more operational domain parameters for the plurality of travel way segments, wherein the one or more operational domain parameters are based, at least in part, on one or more operational capabilities associated with a fleet of autonomous vehicles;
generating, by the computing system, one or more operational domains for the fleet of autonomous vehicles based, at least in part, on the map data and the one or more operational domain parameters, wherein the one or more operational domains are indicative of one or more operational travel way segments of the plurality of travel way segments, the operational travel way segments comprising one or more disconnected operational travel way segments and one or more connected operational travel way segments; and
providing travel way network data indicative of at least one of the one or more operational domains to an autonomous vehicle of the fleet of autonomous vehicles, wherein the autonomous vehicle is configured to traverse the travel way network based, at least in part, on the travel way network data.

14. The computer-implemented method of claim 13, wherein the one or more operational domains comprise a connected operational domain indicative of the one or more connected operational travel way segments and a disconnected operational domain indicative of the one or more connected operational travel way segments and the one or more disconnected operational travel way segments.

15. The computer-implemented method of claim 13, wherein providing the travel way network data comprises:
determining, by the computing system, an operation type associated with the autonomous vehicle, wherein the operation type identifies whether the autonomous vehicle is associated with a vehicle operator; and
determining, by the computing system, the travel way network data for the autonomous vehicle based, at least in part, on the one or more operational domains and the operation type.

16. The computer-implemented method of claim 13, wherein the method further comprises:
obtaining, by the computing system, selection data indicative of a selected operational domain of the one or more operational domains;
obtaining, by the computing system, real-time travel way data associated with the one or more operational travel way segments of the selected operational domain; and
generating, by the computing system, a current routable travel way network for the autonomous vehicle based, at least in part, on the selected operational domain and the real-time travel way data, wherein the current routable travel way network is indicative of a subset of the one or more operational travel way segments.

17. The computer-implemented method of claim 16, wherein the travel way network data is indicative of the current routable travel way network.

18. The computer-implemented method of claim 17, wherein the method further comprises:
obtaining, by the computing system, updated real-time travel way data associated with the one or more operational travel way segments of the selected operational domain, the updated real-time travel way data obtained at a time subsequent to the real-time travel way data; and
generating, by the computing system, an updated current routable travel way network for the autonomous vehicle based, at least in part, on the selected operational domain and the updated real-time travel way data.

19. The computer-implemented method of claim 18, wherein the method further comprises:
providing, by the computing system, the updated current routable travel way network to the autonomous vehicle.

20. A computing system, the computing system comprising:
one or more display devices;
one or more processors; and
one or more tangible, non-transitory, computer readable media that collectively store instructions that when executed by the one or more processors cause the computing system to perform operations, the operations comprising:
obtaining map data associated with a travel way network comprising a plurality of travel way segments, wherein the map data comprises a plurality of segment attributes for each travel way segment of the plurality of travel way segments;
obtaining one or more operational domain parameters for the plurality of travel way segments, wherein the one or more operational domain parameters are based, at least in part, on one or more operational capabilities associated with a fleet of autonomous vehicles;
generating an operational domain for the fleet of autonomous vehicles indicative of one or more operational travel way segments of the plurality of travel way segments based, at least in part, on the map data and the one or more operational parameters, wherein the operational domain is indicative of one or more connected operational travel way segments and one or more disconnected operational travel way segments; and
providing for display, via the one or more display devices, a map interface indicative of the travel way network, the one or more connected operational travel way segments, and the one or more disconnected operational travel way segments.
